(19) United States
(12) Patent Application Publication
(10) Pub. No.: US 2025/0111733 A1
(43) Pub. Date: Apr. 3, 2025

(54) ELECTRONIC GAMING DEVICE WITH REEL BASED BOOST MECHANIC FOR UPDATING A DISPLAYED OUTCOME

(71) Applicant: Aristocrat Technologies, Inc., Las Vegas, NV (US)

(72) Inventors: Daniel Mirjavadi, Las Vegas, NV (US); Allon Englman, Las Vegas, NV (US)

(21) Appl. No.: 18/772,034

(22) Filed: Jul. 12, 2024

Related U.S. Application Data
(60) Provisional application No. 63/586,372, filed on Sep. 28, 2023.

(51) Int. Cl. G07F 17/32; G07F 17/34

(52) U.S. Cl. CPC G07F 17/3213; G07F 17/3267; G07F 17/34

(57) ABSTRACT

An electronic gaming device includes a memory for storing computer executable instructions and processor in communication with the memory. The instructions cause the processor to generate a first outcome of a game based on a first random number generator (“RNG”) output, the first outcome including a plurality of symbols positioned on a plurality of reels and determine that the first outcome does not include a winning symbol combination of a first symbol type. In response to the determination, the processor executes a reel boost mechanic enhancement including determining whether to modify the first outcome by adding symbol of the first symbol type to a first reel. The instructions further cause the processor to determine that the modified first outcome increases an award outcome of the game as compared to the first outcome and cause display of the modified outcome including the modified first reel with the added symbol.

### CROSS REFERENCE TO RELATED APPLICATIONS

This application claims priority to U.S. Provisional Application No. 63/586,372, filed Sep. 28, 2023. The entire contents of which is hereby incorporated by reference.

### TECHNICAL FIELD

The field of disclosure relates generally to electronic gaming devices, and more specifically, to network-based electronic gaming devices that are programmed with a reel-based boost mechanic that is triggered based on an initial game outcome and causes a second game outcome to be displayed wherein the second game outcome is an improved outcome as compared to the first game outcome.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency, or number of secondary games, and/or the amount awarded.

Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Upon initiation of play, the RNG randomly determines a game outcome and symbols are then selected which correspond to that outcome. Notably, some games may include an element of skill on the part of the player and are therefore not entirely random.

### BRIEF DESCRIPTION

In one aspect, an electronic gaming device includes a memory for storing computer executable instructions and at least one processor in communication with the memory. The instructions, when executed by the at least one processor, cause the at least one processor to generate a first outcome of a game based on a first random number generator (“RNG”) output, the first outcome including a plurality of symbols positioned on a plurality of reels and determine that the first outcome does not include a winning symbol combination of a first symbol type. In response to the determination, the instructions further cause the processor to execute a reel boost mechanic enhancement including determining whether to modify the first outcome by adding at least one symbol of the first symbol type to a first reel. The instructions further cause the processor to determine that the modified first outcome increases an award outcome of the game as compared to the first outcome and cause display of the modified outcome including the modified first reel with the at least one added symbol.

In another aspect, a method of electronic gaming implemented by at least one processor in communication with at least one memory is provided. The method includes generating a first outcome of a game based on a first random number generator (“RNG”) output, the first outcome including a plurality of symbols positioned on a plurality of reels and determining that the first outcome does not include a winning symbol combination of a first symbol type. In response to the determination, the method further includes executing a reel boost mechanic enhancement including determining whether to modify the first outcome by adding at least one symbol of the first symbol type to a first reel. The method further includes determining that the modified first outcome increases an award outcome of the game as compared to the first outcome and causing display of the modified outcome including the modified first reel with the at least one added symbol.

In yet another aspect, at least one non-transitory computer-readable storage medium with instructions stored thereon is provided. The instructions, in response to execution by a processor, cause the processor to generate a first outcome of a game based on a first random number generator (“RNG”) output, the first outcome including a plurality of symbols positioned on a plurality of reels and determine that the first outcome does not include a winning symbol combination of a first symbol type. In response to the determination, the instructions further cause the processor to execute a reel boost mechanic enhancement including determining whether to modify the first outcome by adding at least one symbol of the first symbol type to a first reel. The instructions further cause the processor to determine that the modified first outcome increases an award outcome of the game as compared to the first outcome and cause display of the modified outcome including the modified first reel with the at least one added symbol.

In yet another aspect, an electronic gaming device is provided. The electronic gaming device includes a memory for storing computer executable instructions and a processor in communication with the memory. The instructions, when executed by the processor, cause the processor to generate a preliminary outcome of a game based on a first random number generator (“RNG”) output, the preliminary outcome including a plurality of symbols positioned in a plurality of reels and determine that the preliminary outcome of the first game instance does not include a winning symbol combination of a first symbol type. In response to the determination, the processor is caused to change the preliminary outcome to a modified outcome by altering at least one reel of the plurality of reels by to include the first symbol type. The instructions further cause the processor to determine that the modified outcome does not include a winning symbol combination of the first symbol type and in response to determining that the modified outcome does not include a winning symbol combination of the first symbol type, cause display of the preliminary outcome of the game.

In yet another aspect, an electronic gaming device is provided. The electronic gaming device includes a memory for storing computer executable instructions and a processor in communication with the memory. The instructions, when executed by the processor, cause the processor to generate a first outcome of a game based on a first random number generator (“RNG”) output, the first outcome including a plurality of symbols positioned in a plurality of reels and determine to execute a reel boost mechanic enhancement based on the first outcome and by performing a first lookup using a second RNG output and a first lookup table. Executing the reel boost mechanic enhancement causes the processor to identify a first reel of the plurality of reels that does not include a first symbol type for the first outcome, perform a second lookup using a third RNG output and a second lookup table associated with the first reel, determine to add a first number of a first symbol type to the first reel based on the second lookup. In response to the determination, the processor identifies a second reel of the plurality of reels that does not include the first symbol type for the first outcome. The processor further performs a third lookup using a fourth RNG output and a third lookup table associated with the second reel and determines to add a second number of the first symbol type to the second reel based on the third lookup. The instructions further cause the processor to determine a second outcome of the game based on the executed reel boost mechanic enhancement.

### BRIEF DESCRIPTION OF THE DRAWINGS

FIG. 1 is an exemplary diagram showing several EGMs networked with various gaming related servers.

FIG. 2A is a block diagram showing various functional elements of an exemplary EGM.

FIG. 2B depicts a casino gaming environment according to one example.

FIG. 2C is a diagram that shows examples of components of a system for providing online gaming according to some aspects of the present disclosure.

FIG. 3 illustrates, in block diagram form, an implementation of a game processing architecture algorithm that implements a game processing pipeline for the play of a game in accordance with various implementations described herein.

FIG. 4 illustrates an example screen shot or user interface of a game played on an electronic gaming device.

FIG. 5 illustrates another example screen shot or user interface of the game shown in FIG. 4.

FIG. 6 illustrates another screen shot or user interface of the game shown in FIG. 4.

FIG. 7 illustrates another screen shot or user interface of the game shown in FIG. 4.

FIG. 8 illustrates an example screen shot or user interface of another game played on an electronic gaming device.

FIG. 9 illustrates another screen shot or user interface of the game shown in FIG. 8.

FIG. 10 illustrates another screen shot or user interface of the game shown in FIG. 8.

FIG. 11 illustrates another screen shot or user interface of the game shown in FIG. 8.

FIG. 12 illustrates another screen shot or user interface of the game shown in FIG. 8.

FIG. 13 illustrates another screen shot or user interface of the game shown in FIG. 8.

FIG. 14 illustrates an example screen shot or user interface of another game played on the electronic gaming device.

FIG. 15 illustrates another screen shot or user interface of the game shown in FIG. 8.

FIG. 16 is a flow diagram illustrating an exemplary method of conducting a reel boost mechanic on the electronic gaming device shown in FIGS. 4-15 in accordance with the present disclosure.

FIG. 17 is another flow diagram illustrating an exemplary method of conducting a reel boost mechanic on the electronic gaming device shown in FIGS. 4-15 in accordance with the present disclosure.

FIG. 18 illustrates an example screen shot or user interface of another game played on an electronic gaming device.

FIG. 19 illustrates another screen shot or user interface of the game shown in FIG. 18.

FIG. 20 illustrates another screen shot or user interface of the game shown in FIG. 18.

FIG. 21 illustrates another screen shot or user interface of the game shown in FIG. 18.

FIG. 22 illustrates another screen shot or user interface of the game shown in FIG. 18.

FIG. 23 illustrates another screen shot or user interface of the game shown in FIG. 18.

FIG. 24 illustrates an example screen shot or user interface of another game played on an electronic gaming device.

FIG. 25 illustrates another screen shot or user interface of the game shown in FIG. 24.

FIG. 26 illustrates another screen shot or user interface of the game shown in FIG. 24.

FIG. 27 illustrates another screen shot or user interface of the game shown in FIG. 24.

FIG. 28 illustrates another screen shot or user interface of the game shown in FIG. 24.

FIG. 29 is an image of the screen shot or user interface shown in FIG. 18.

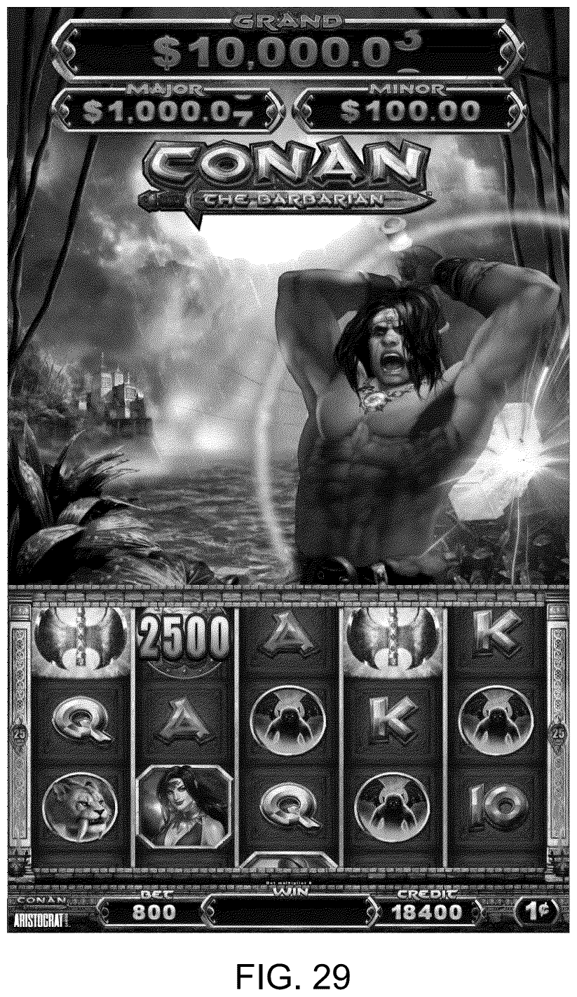

FIG. 30 is an image of the screen shot or user interface shown in FIG. 19.

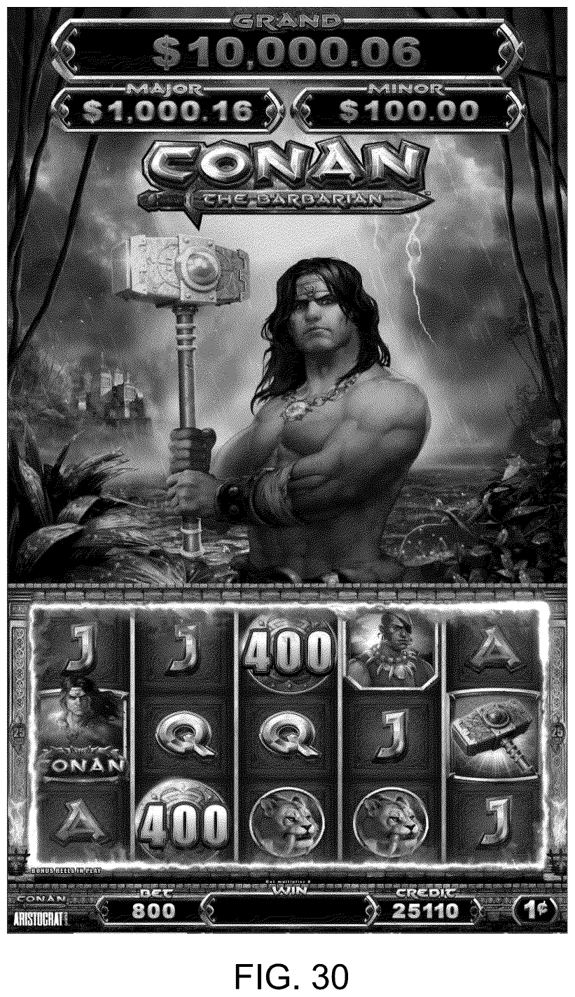

FIG. 31 is an image of the screen shot or user interface shown in FIG. 20.

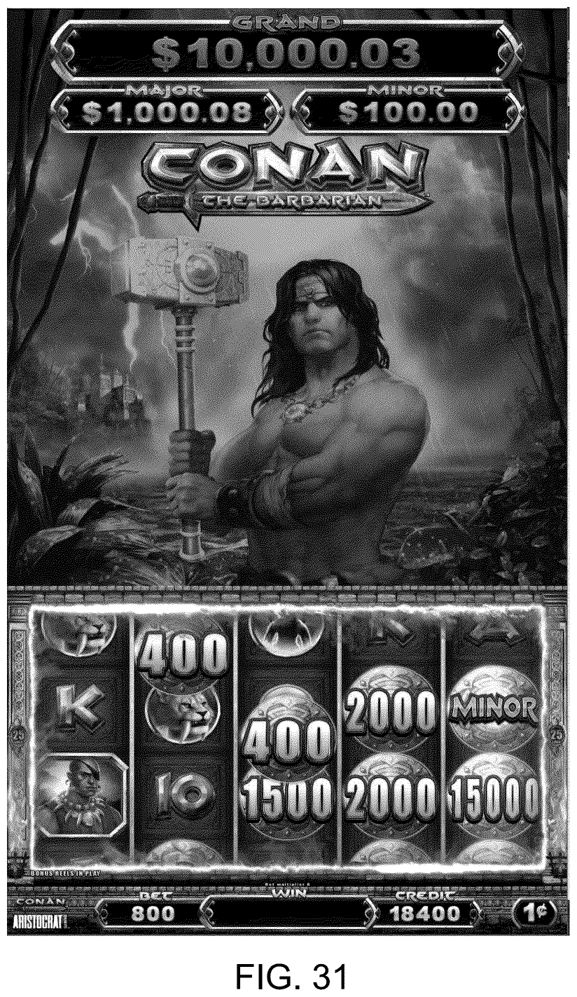

FIG. 32 is an image of the screen shot or user interface shown in FIG. 21.

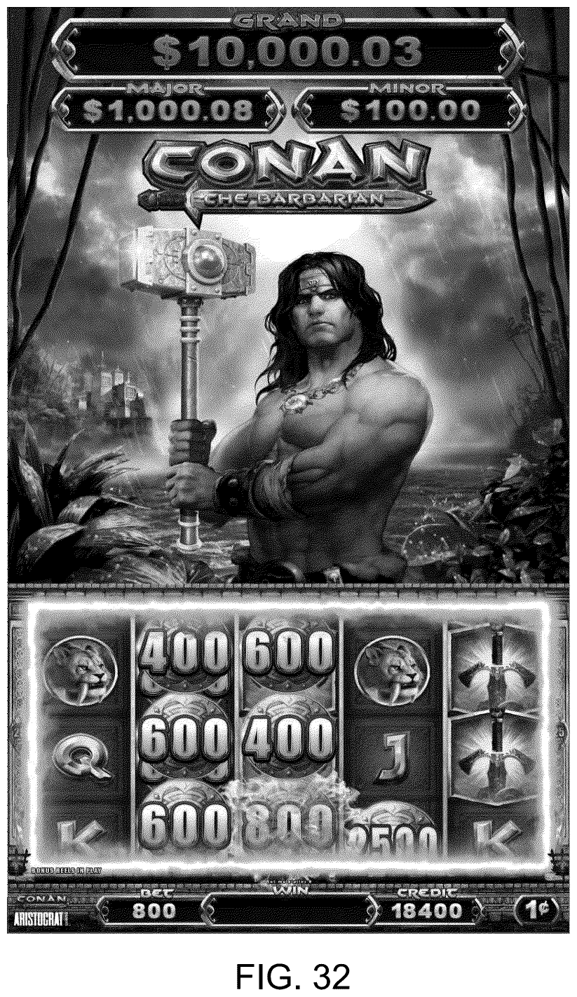

FIG. 33 is an image of the screen shot or user interface shown in FIG. 22.

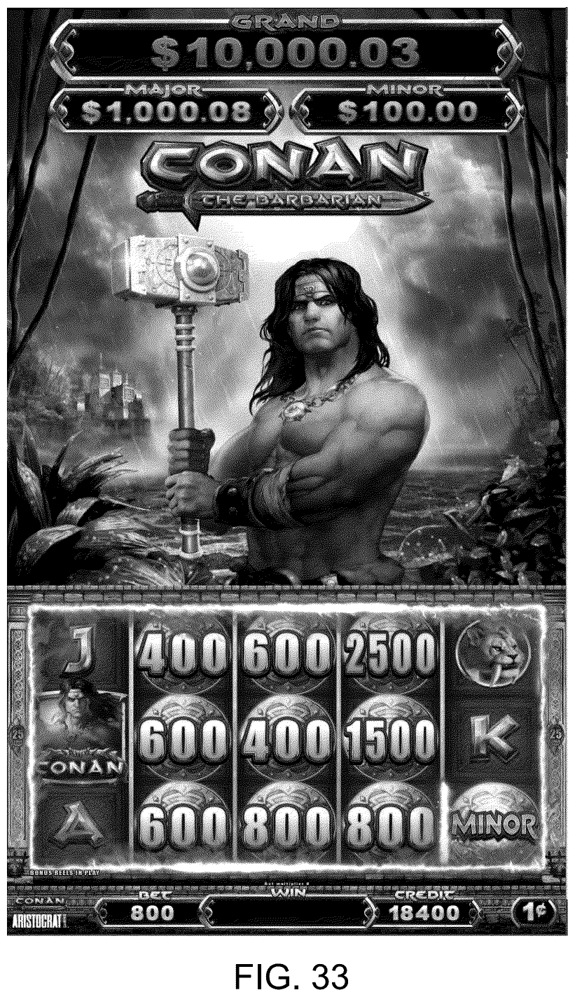

FIG. 34 is an image of the screen shot or user interface shown in FIG. 23.

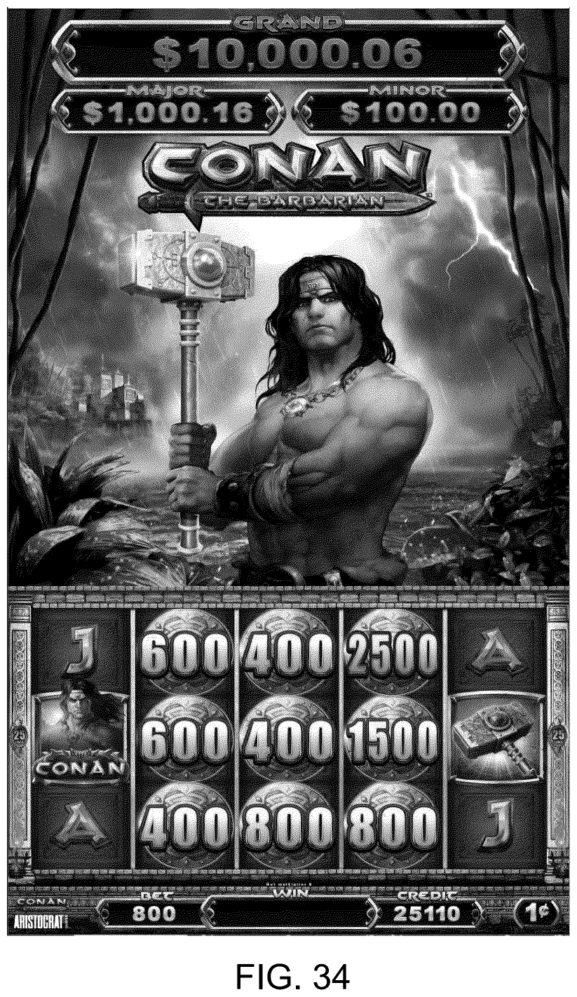

FIG. 35 is an image of the screen shot or user interface shown in FIG. 24.

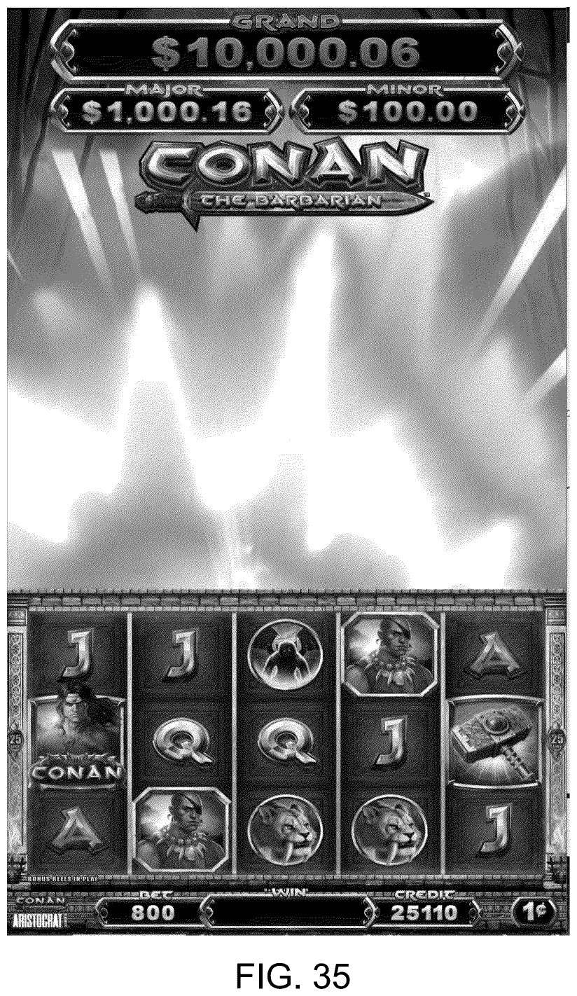

FIG. 36 is an image of the screen shot or user interface shown in FIG. 25.

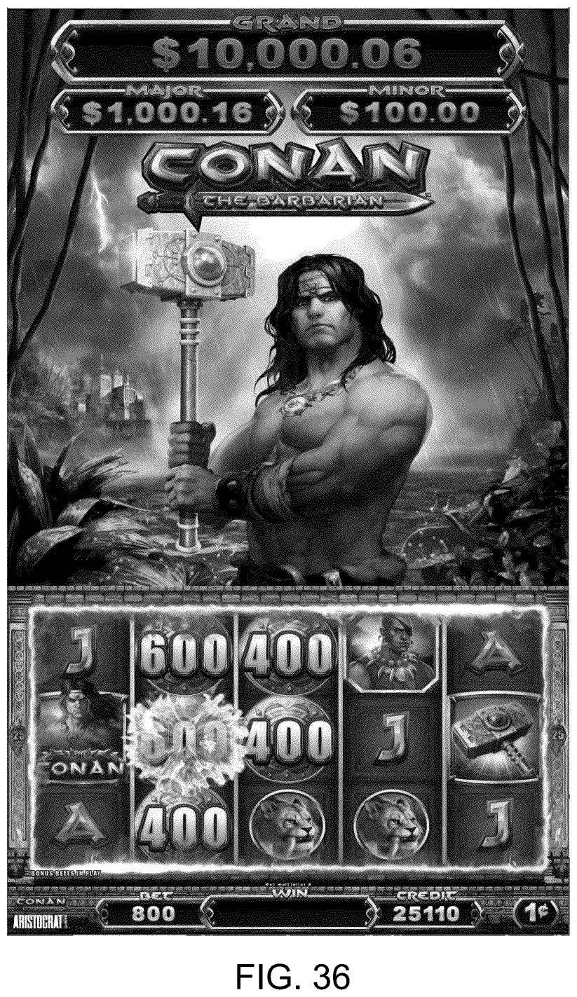

FIG. 37 is an image of the screen shot or user interface shown in FIG. 26.

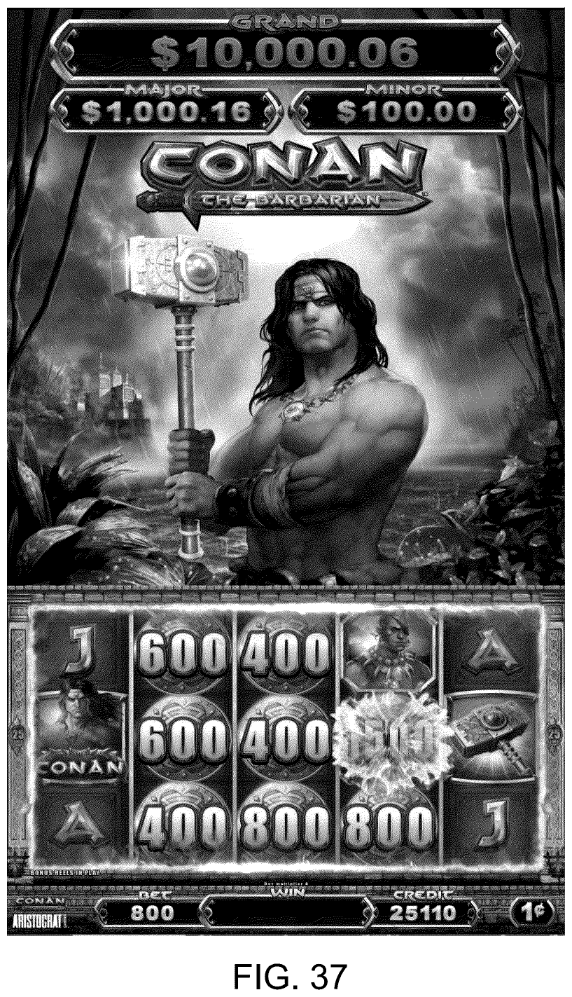

FIG. 38 is an image of the screen shot or user interface shown in FIG. 27.

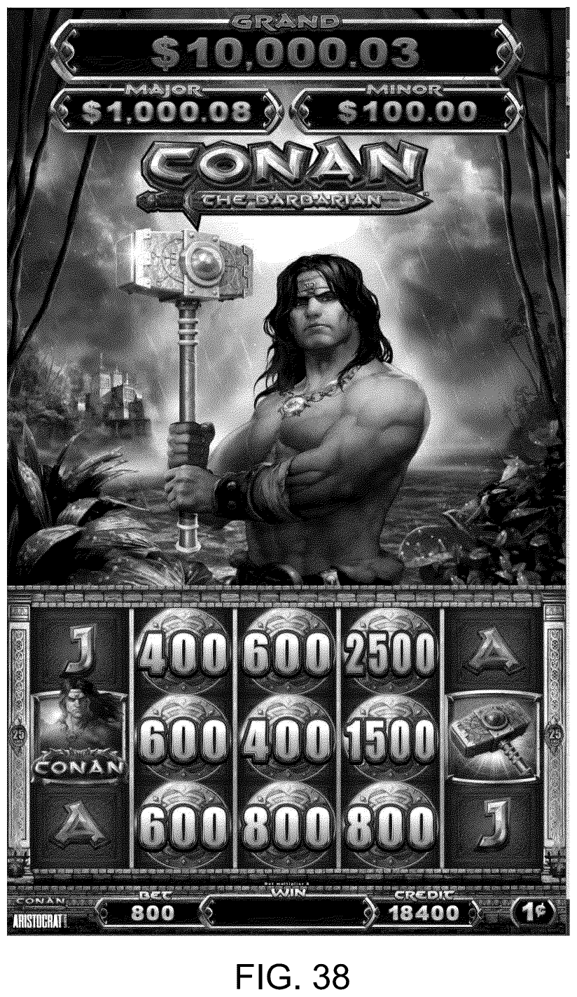

FIG. 39 is an image of the screen shot or user interface shown in FIG. 28.

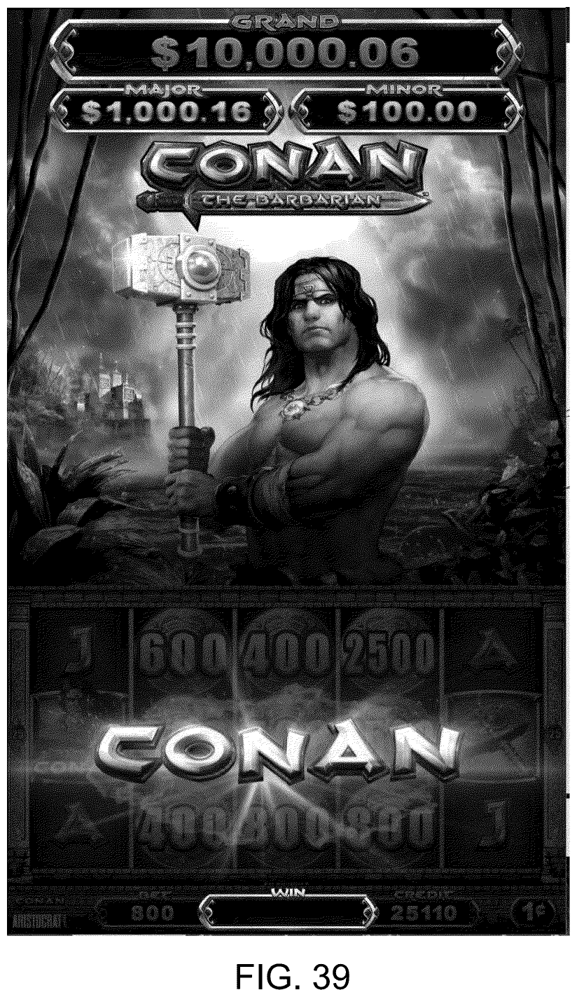

### DETAILED DESCRIPTION

Embodiments described herein are directed to electronic gaming and, more particularly, to electronic gaming devices with a reel boost mechanic, also referred to herein as a “reel boost mechanic enhancement”. During play of the game, a matrix including a plurality of symbol positions arranged in a plurality of columns and a plurality of rows is displayed to the user. When the game is initiated, an initial or “first” game outcome is determined based on an output of a random number generator (“RNG”). The initial game outcome includes a plurality of symbols populated within the symbol positions of the matrix. A lookup of a paytable is performed using the RNG outcome to determine the initial game outcome. The lookup may include selecting stopping positions of one or more reels that are associated with each of the columns and include the symbols thereon. A processor of the gaming device determines, based on the initial game outcome, whether to activate a reel boost mechanic to generate a second game outcome.

The reel boost mechanic enhances the initial game outcome, such as by converting a game outcome including losing symbol combinations to a game outcome including winning symbol combinations. Losing symbol combinations may refer to an outcome in which a predetermined number and/or pattern (i.e., consecutive columns) of credit symbols are not landed. If the predetermined number and/or pattern of credit symbols are landed, a “winning” symbol combination occurs. Winning symbol combinations may trigger a credit award, an increase to a credit award, and/or awarding or “unlocking” a bonus game.

In some embodiments described herein, the processor determines whether to activate the reel boost mechanic based on the initial game outcome and according to predefined instructions and/or a rules engine of the gaming device. If the initial outcome does not include a predetermined number or pattern of symbols, the reel boost mechanic is initiated. As an example, in some embodiments, a winning outcome is based on a pattern of repeating symbol types across different consecutive columns of the matrix. In one embodiment, landing at least one repeating symbol type (e.g., cash on reel (“COR”) symbols, also referred to herein as “credit symbols”) in each of at least the first three leftmost columns is required for a credit award. Landing a credit symbol in each of five columns unlocks a metamorphic feature. In some such embodiments, the reel boost mechanic may be initiated and applied to each column that does not include the predetermined number of credit symbols (i.e., one credit symbol). The processor identifies columns that do not include any credit symbols and performs a lookup using an RNG output and a lookup table associated with the column. A plurality of lookup tables may each be associated with one of the columns and may include different weighted probabilities for adding the credit symbols to a given column. In some embodiments, if the initial game outcome does not include the predetermined number and/or pattern of credit symbols, an additional RNG pull and lookup may be performed to determine whether to initiate the reel boost mechanic.

As an example, where a credit symbol lands in only the first column and the remaining columns do not include a credit symbol, the reel boost mechanic is first applied to a second column. The reel boost mechanic determines, using an additional RNG pull and lookup of a weight table associated with the second column, a number of credit symbols to add for the second column, ranging from zero to three for a three-row matrix. If the reel boost mechanic determines that zero additional credit symbols are to be added for the second column the mechanic is ended and is not applied to the remaining columns. If the reel boost mechanic determines that at least one credit symbol is added to the second columns, the reel boost mechanic is then applied to the third column, using an additional RNG pull and lookup of a weight table associated with the third column. This process is repeated for each of the columns sequentially and is stopped when, after the reel boost mechanic is applied to a given column, the column still does not include credit symbols.

In some embodiments, the reel boost mechanic is performed in the background and only displayed in the matrix if the reel boost mechanic changes the game outcome. As an example, where the reel boost mechanic is run on the third column and no additional COR symbols are present in the second game outcome, the initial game outcome may be displayed in the matrix and the reel boost mechanic is not displayed such that the player is unaware that the reel boost mechanic was run. If the reel boost mechanic changes the game outcome, such that the game outcome includes the predetermined number of credit symbols, the second game outcome may be displayed in combination with one or more display messages or animations to indicate to the player that the reel boost mechanic was activated and improved the game outcome. In such embodiments, the player is only made aware of the reel boost mechanic where the game outcome changes, thereby increasing player anticipation/excitement.

Embodiments described herein are programmed to achieve a designated game return-to-player (RTP) by improving the gaming device operation/capability including randomly generating and adding designated (e.g., COR) symbols onto one or more target reels in order to generate a winning pattern combination. In particular, after the gaming device generates a first game outcome, the gaming device determines if a designated symbol (e.g., COR symbol) is displayed on any of the reels. For reels that did not land a credit symbol, the gaming device randomly determines, in a sequential manner, whether to add one or more credit symbols to the reels that did not previously land a credit symbol. One or more configurable elements of the game, such as the reels, paytables, and/or rules engine are set such that an overall RTP may be maintained, accounting for upgraded awards triggered by the reel boost mechanic. For example, in some embodiments, an RTP for the initial game outcome is lowered relative to an overall RTP of the game to account for the increased payouts resulting from triggering of the reel boost mechanic. Additionally, in embodiments in which the reel boost mechanic is applied to multiple successive columns, different paytables may be used for each column and/or may be used based on whether the reel boost mechanic changed a game outcome as applied to a preceding column.

The gaming device may include a metamorphic feature that is triggered by landing a threshold number of credit symbols. In some embodiments, a gaming device may require 6 credit symbols to land to trigger the metamorphic feature. In some instances, the gaming device may generate a game outcome that almost lands all required 6 credit symbols, for example, landing 5 credit symbols. When such a game outcome occurs, the gaming device provides a second opportunity to trigger the metamorphic feature by performing a separate RNG pull to determine whether to add one or more credit symbols to satisfy the threshold number. By doing so, the gaming device provides an additional opportunity to land more credit symbols, and in some cases landing more credit symbols to satisfy the number of credit symbols necessary to trigger the metamorphic feature. However, because such second opportunities may be based on landing a threshold number of credit symbols, the gaming device does not care where the credit symbols land in a reel matrix, e.g., a column representative of a single reel, and a row representing a place within a reel. Accordingly, in embodiments described herein, the reel boost mechanism may add the credit symbols randomly, at any position in the reel matrix. However, because generating a winning pattern combination may require adding credit symbols to specific reels, the gaming device includes one or more additional control functions for properly adding credit symbols onto specified reels.

Embodiments described herein for the reel boost mechanic are technically rooted in gaming technology for adding credit symbols onto specified reels. To provide a degree of randomness while providing a reel boost mechanic, the game processing pipeline implements one or more of the following steps, including, and without limitation i) checking landing credit symbols, ii) executing a reel boost mechanic to a first outcome including a line win, and/or iii) executing a reel boost mechanic to a first game outcome including a failed outcome.

In some embodiments, checking landing credit symbols during reel spins may include after a player hits the spin button, the gaming device generates a first game outcome while players may observe the reels spins. While the reels are spinning, the gaming device checks whether the first game outcome generates a winning pattern combination based on the credit symbols that land. As an example, the gaming device could pay left to right and if credit symbols land on reels 1-3, then the gaming device includes a winning 3 of a kind pattern. If the first game outcome does not include a winning pattern combination for the credit symbols that land, the gaming device then checks and determines which reels have not landed credit symbols. For example, in a 5 reel (also referred to herein as a column) game, if the first gaming outcome lands credit symbols on reels 1 and 3, the gaming device will determine whether that reels 2, 4, and 5 do not have any credit symbols

In some embodiments, executing a reel boost mechanic to a first outcome including a line win may include the reel boost mechanic may occur, or execute, during a period of time while reel spin or, alternatively, after one or more of the reels have stop. In some embodiments, adding of credit symbols can occur when the player sees the reels spinning or after the reels stop spinning. For line wins that appear the first game outcome that could be replaced by the reel boost mechanic, the reel boost mechanic is shown to a player after the reels stop. By doing so, the gaming device presents to the player that the player will be awarded both the line win and the win generated from the reel boost mechanic. If the first game outcome does not include any line wins that could be replaced by the reel boost mechanic, the reel boost mechanic is presented to the player while one or more reels are spinning.

In some embodiments, if the first game outcome fails to generate a winning pattern combination with the credit symbols, the gaming device will add one or more credit symbols on reels that do not land a credit symbol in the first game outcome. The gaming device will check the reels in a sequential manner. For example, if the first game outcome lands credit symbols on reels 1 and 3, the gaming device will determine first whether to add credit symbols to reel 2. If the gaming device determines to randomly add credit symbols to reel 2, the gaming device will determine whether to add credit symbols to the next reel, for example, reel 4. If the gaming device determines not to add credit symbols to reel 2, the reel boost mechanic ends and no credit symbols are added to the first game outcome since a winning pattern combination cannot be generated.

In some embodiments, the reel boost mechanic is only displayed when the gaming device generates a winning pattern combination. The gaming device continues to check the reels in a sequential manner for the remaining reels. In some embodiments, each reel is associated with a lookup table used to determine how many credit symbols to add to the reel.

Embodiments described herein improve the game process pipeline by adding credit values to one or more reels to generate a winning pattern combination, replacing a previous failed pattern combination. The embodiments described herein achieve a designated RTP for improved gaming device capability by adding credits onto target reel to generate the replacement winning pattern combination.

Embodiments described herein address technical problem of the inability of known gaming systems to provide a random based game outcome that uses a boost mechanic that guarantees generating left-to-right column based winning combinations when the mechanic is displayed to a player. As an example, at least some known gaming devices utilize a mechanic that simply evaluates whether the total number of special symbols landing in a matrix are at a pre-existing threshold number (e.g., need to land 6 or more credit symbols). Such systems do not evaluate the symbol positions within the matrix, such as which reels the special symbols land on or whether any positional patterns are formed. Instead, such systems randomly place a special symbol on in reel matrix grid to boost a game outcome. At least some other known gaming devices utilize a mechanic that simply re-spins all of the reels (i.e., perform RNG calls for each reel) multiple times until the game outcome produces a desired left-to-right winning combination. Such systems provide little control on how much the mechanics could potentially pay out or how many game outcomes would be generated behind the scenes before a game outcome can be shown to a player.

Embodiments described herein provide a technical solution to the above-described technical problems by utilizing a reel based boost mechanic that provides an improved and more efficient control over managing game randomness when the reel boost mechanic must generate a left-to-right winning symbol combination. When an initial game outcome does not include a left-to-right winning combination for a special symbol type (i.e., credit symbols), the reel boost mechanic is initiated. The initiation of the reel boost mechanic includes checking reels that fail to land the special symbol type in a left-to-right sequential manner. A left most reel that fails to land the special symbol type is first identified (e.g., a second reel of five reels). The processor then determines whether to add one or more credit symbols to the second reel by performing a first lookup using a RNG output and a first lookup table associated with the first reel. If the processor determines not to add any credit symbols to the second reel, the boost mechanic is terminated. If the processor determines to add one or more credit symbols to the second reel, the third through fifth reels are checked for any reels that do not include credit symbols and the reel boost mechanic is applied to the next reel identified. For example, where the third reel includes a credit symbol in the initial outcome and the fourth reel does not, the boost mechanic is next applied to the fourth reel using a new RNG output and a lookup table. The lookup tables for each of the reels may include differing weighted probabilities. This process is repeated until the boost mechanic is either terminated based on failing to add a credit symbol to one of the reels or being executed on the last reel (e.g., the fifth reel). After the boost mechanic is terminated, the reels, as updated by the reel boost mechanic, are evaluated for any winning symbol combinations. If the reels still fail to include winning symbol combinations, the boost mechanic is not displayed to the player. If the reel boost mechanic results in at least one winning symbol combination that was not initially present in the initial outcome, the reel boost mechanic is displayed to the player. The memory may store a minimum number and/or pattern of credit symbols that are needed to exist in the outcome for a winning combination.

The technical problems addressed herein include: (i) inability of known systems to provide a reel boost mechanic that is targeted to specific reels for changing a losing combination of symbols to a winning combination of symbols; (ii) inability of known systems to apply a reel boost mechanic in a background operation and only cause display of the reel boost mechanic in response to a determination that the mechanic changes a losing combination of symbols to a winning combination of symbols; (iii) inability of known systems to provide a secondary improved combination of symbols while preserving line wins of an initial game outcome; (iv) inability of known systems to identify initial combination of symbols that require only a modest targeted change to the outcomes to achieve a predetermined number of a symbol type; (v) inability of known gaming devices to provided improved display variance for winning pattern combinations while maintaining an overall game RTP; (vi) inefficient use of computer resources at least because of burdensome processing requirements when determining secondary outcomes; (vii) inefficient use of computer resources at least because of burdensome processing requirements when determining whether to calculate a secondary outcome by limiting the RNG and lookups for each reel to only proceed where an improved secondary outcome is still possible in view of prior lookups for preceding reels; and (viii) lack of processing availability and speed in known gaming systems at least because of the burdensome processing requirements.

The resulting technical effect and/or technical benefits achieved herein include at least one of: (i) ability to provide a reel boost mechanic that targets specific reels by identifying reels that do not include a symbol type (e.g., credit symbols) and applying the reel boost mechanic to the identified reels in response; (ii) ability to apply a reel boost mechanic in a background operation and only cause display of the reel boost mechanic in response to a determination that the mechanic changes the game outcome to include a winning symbol combination; (iii) ability to provide a secondary improved game outcome while preserving line wins of an initial game outcome; (iv) ability to identify initial game outcomes that are close to a winning combination of symbols by analyzing symbols in each row after generation of the initial game outcome and identifying one or more columns or reels according to a rules engine that could be changed to change the game outcome; (v) ability to provide improved display variance for winning pattern combinations while maintaining an overall game RTP by utilizing different RNG outputs only for those columns identified according to the rules engine and configuring play of the game such that an RTP for the initial outcomes is less than the overall game RTP; (vi) improved efficiency in the use of computer resources when determining secondary outcomes by limiting the RNG and lookups for new symbols to only those symbols or columns which are not contributing to a predetermined number and/or pattern of a symbol type; (vii) improved efficiency in the use of computer resources when determining whether to calculate a secondary outcome by limiting the RNG and lookups for each reel to only proceed where an improved secondary outcome is still possible in view of prior lookups for preceding reels; and (viii) improved of processing availability and speed at least because of the improved efficiency in the use of computer resources.

As a result, embodiments of the reel boost mechanic described herein provide an improved and more efficient control process in managing the game randomness when the reel boost mechanic must generate a left-to-right win combination. When the game fails to generate a left-to-right winning combination for a special symbol type (e.g., credit symbols) in a first game outcome, the game starts the reel boost mechanic. The game starts checking reels that fail to land the special symbol type in a left-to-right sequential manner. The game first checks the left most reel that fails to land the special symbol type (e.g., reel 2). If the game determines not to add a credit symbol, the reel boost mechanic exits and the first game outcome without the winning combination is shown the player. If the game determines to add at least one credit symbol, the game moves right onto the next reel (e.g., reel 3) and performs this same check. The game can set a minimum number of special symbol types that needs to exist to before it's a winning combination.

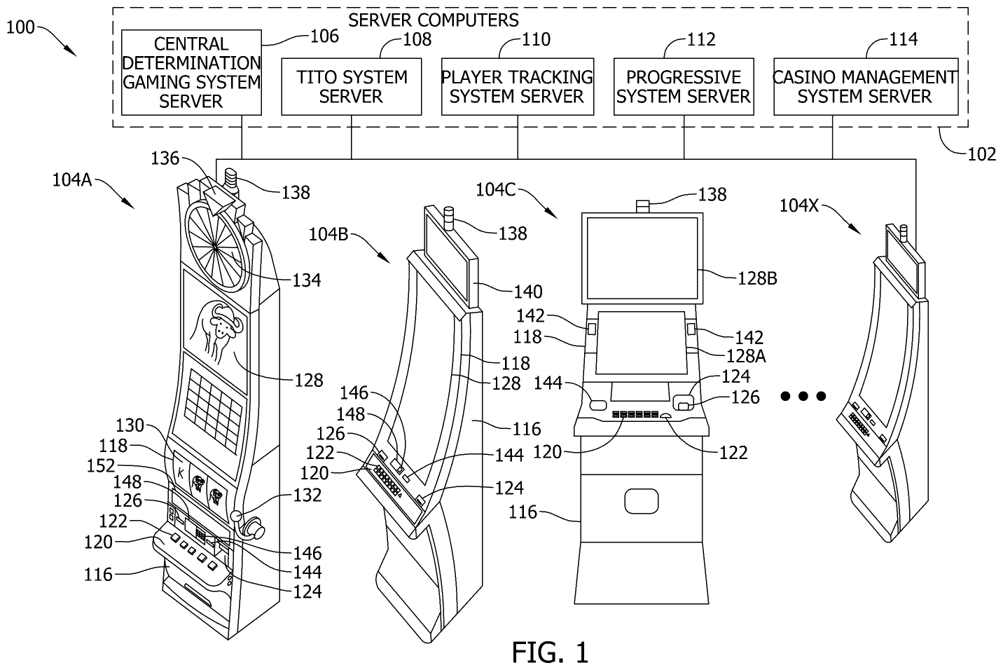

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementation, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

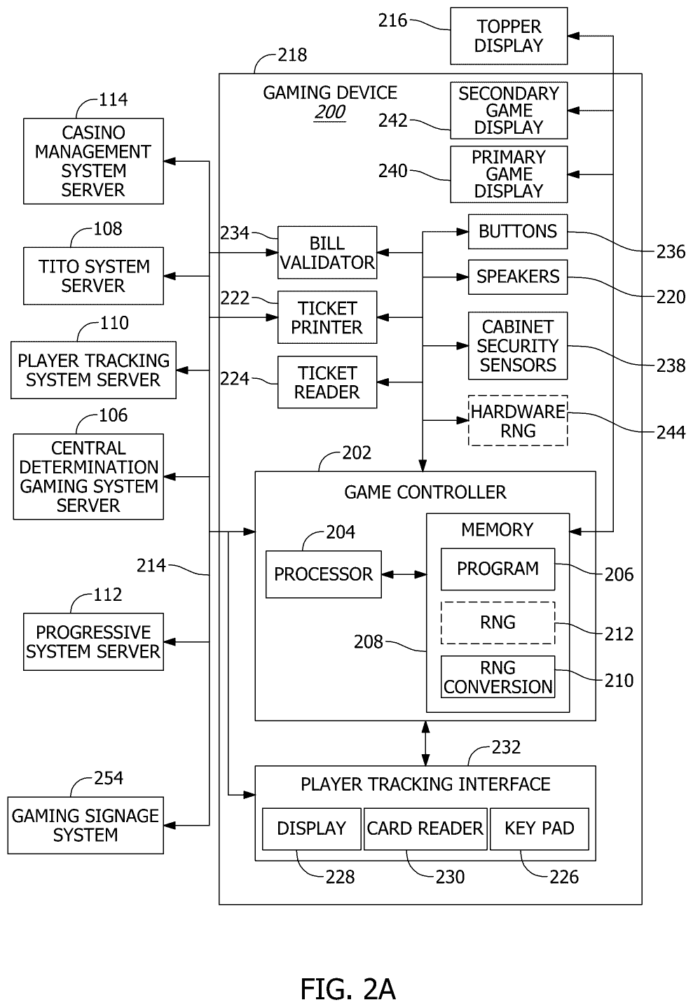

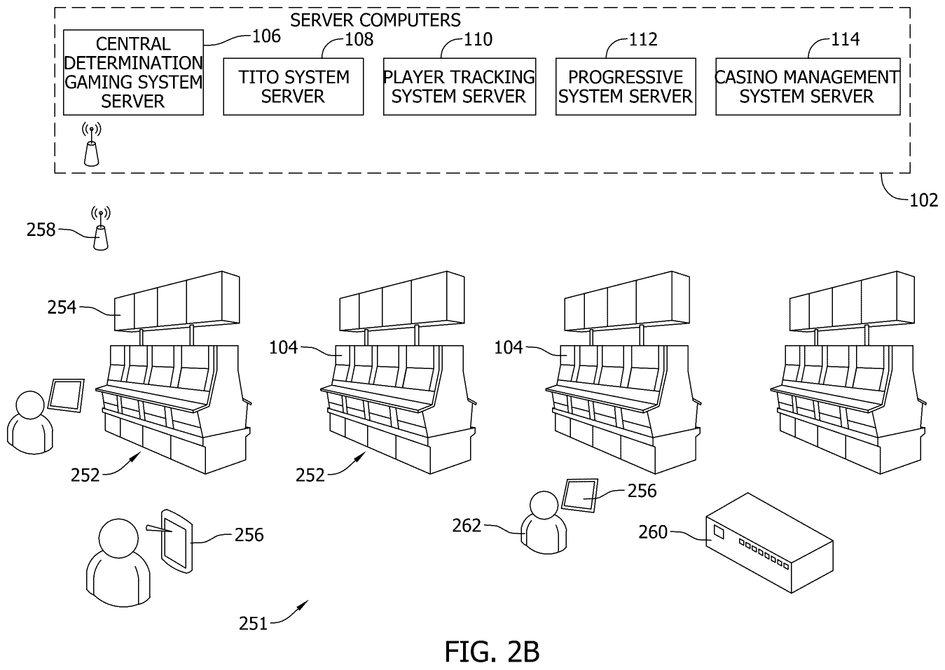

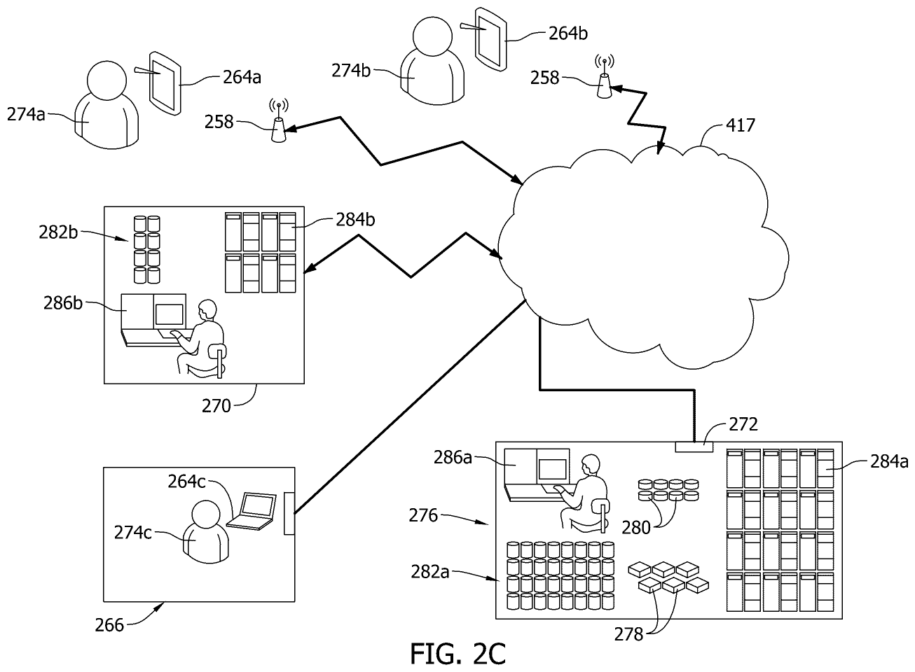

Many or all the above-described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc™ model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play or any other information or media desired by the game designer or operator. In some implementations, example gaming device 104C may also include speakers 142 to output various audio such as game sound, background music, etc.

Many different types of games, including mechanical slot games, video slot games, video poker, video blackjack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2 also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random-access memory (SRAM), dynamic random-access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g., amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types, and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 286a. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

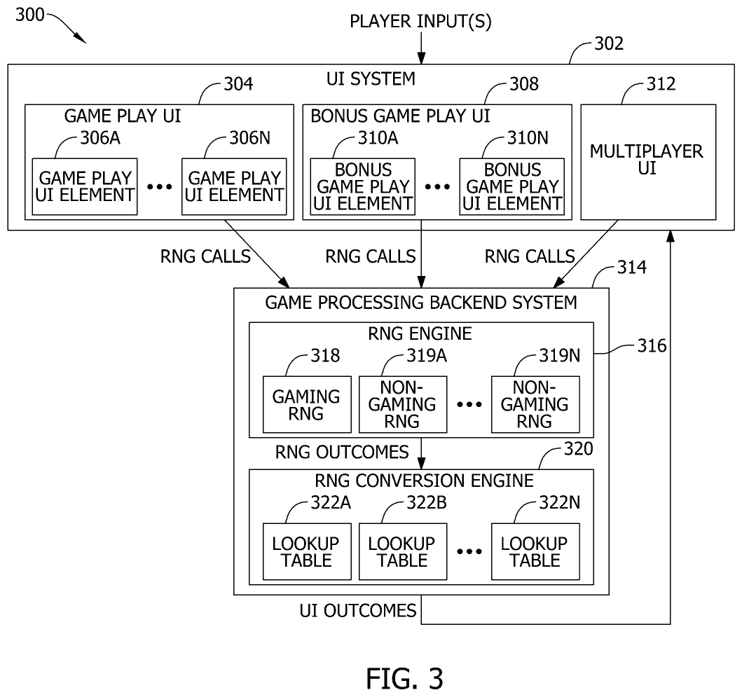

FIG. 3 illustrates, in block diagram form, an implementation of a game processing architecture 300 that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. In other implementations, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could corresponds to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

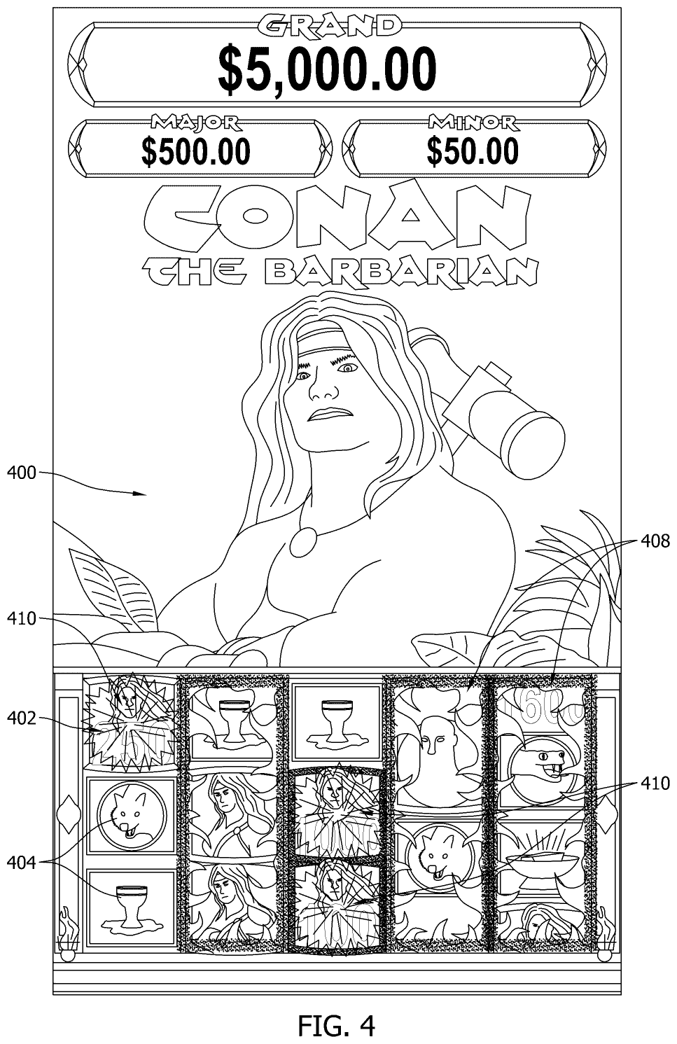

FIG. 4 illustrates an example EGM screen 400 of a base game, which may be displayed on a display screen of an EGM (e.g., EGM 104) and may be controlled via, for example, a controller (e.g., game controller 202) that includes at least one processor in communication with at least one memory. As shown in FIG. 4, EGM screen 400 includes a game play matrix display area 402 that displays a game play matrix. The game play matrix has columns 408 (also referred to herein as a reels 408) and rows of symbol positions. Symbols 404 are generally displayed within game play matrix display area 402. In the illustrated embodiment, EGM screen 400 includes five reels 408 (e.g., from reel 408 one on the left side to reel 408 five on the right side) with symbols 404 displayed in game play matrix display area 402. Each reel 408 displays three symbols 404, and each reel 408 generally has the same height. In some embodiments, the number of symbols 404 being displayed in each reel 408 of the game play matrix is between 1 and n, where n is a real number. In other embodiments, each reel 408 may display any suitable number of symbols 404 (e.g., between three and six symbols 404). While an example embodiment is described herein with respect to an EGM (e.g., EGM screen 400), it should be appreciated that online and mobile embodiments are envisioned (e.g., where the embodiments described herein are provided at an end user device (e.g., EUDs 264a-c)).

During a turn of gameplay (e.g., during a spin/play), an output (e.g., displayed symbols) is determined for the EGM game, and the output includes a plurality of symbols 404 arranged in symbol positions within one or more of reels 408. An output may refer to the final combination of symbols arranged in the reels 408 and rows, or a resultant outcome stemming from the combination, e.g., a winning outcome or a losing outcome. A predefined number of symbols 404 are each independently and randomly determined for each reel 408 (e.g., using RNG 212 and RNG conversion engine 210, 320). That is, each symbol position may be its own reel 408 that is randomly and independently determined during each spin. In some embodiments, the plurality of symbols 404 may include at least one cash on reel (“COR”) symbol 410 (also referred to herein as a credit symbol). Cash on reel symbols 410 may be associated with a credit amount displayed in the symbols 410.

A number of the randomly determined symbols 404 for each respective reel 408 are randomly selected (e.g., via a controller and/or using RNG 212 and RNG conversion engine 210, 320) to be displayed in each respective reel 408. For example, in some embodiments, three symbols 404 may be separately and randomly determined for each reel 408. That is, fifteen individual symbols 404 may be randomly determined for the game play matrix (e.g., three symbols per each of the five reels 408), and each individual symbol 404 may be randomly determined independently of the other randomly determined symbols 404. Then, a number of symbols 404 randomly determined for each respective reel 408 may be selected to be displayed in each respective reel 408 (e.g., by a controller). For example, in a first (e.g., left most reel 408) reel 408 of a five-reel configuration, three symbols 404 randomly determined for the first reel 408 may be randomly determined to be displayed in the first reel 408 (e.g., as shown in FIG. 4). For each reel 408, the number of cash on reel symbols 410 displayed in a reel 408 are determined by a random and independent determination of a predefined number including 0 (e.g., no cash on reel symbols 410), 1, 2, or 3 cash on reel symbols 410, as determine by drawing values from a lookup table.

Referring again to FIG. 4, reels 408 one (i.e., the left most reel in FIG. 4) and three (i.e., the third left most reel in FIG. 4) are stopped and each include cash on reel symbols 410, e.g., reel 408 one includes one cash on reel symbol 410 and reel 408 three includes two cash on reel symbols 410. FIG. 4 also shows reels 408 two, four, and five are still spinning. In reference to FIGS. 4-7, the reel boost mechanic feature has been initiated, in particular, the reel boost mechanic has been executed and is successful. The reel boost mechanic may be executed when one or more trigger conditions have been satisfied. In the example embodiment, the trigger condition includes a determination that the first outcome does not include a winning combination of cash on reel symbols 410 according to a predetermined number and/or pattern. The reel boost mechanic is applied independently to the reels 408 starting with a leftmost reel 408 that does not include cash on reel symbols 410 in the initial outcome. The reel boost mechanic is applied to any successive columns that do not include the cash on reel symbols 410 in the initial outcome if the mechanic adds a cash on reel symbols 410 to the preceding column. The reel boost mechanic is successful when execution of the reel boost mechanic results in a second outcome that includes a winning cash on reel symbol combination based predetermined number and/or pattern.

When the reel boost mechanic has been initiated, initially, one or more reels 408 may be stopped and one or more reels 408 may continue to spin, building a player's anticipation. In some embodiments, initially stopped reels 408 include one or more cash on reel symbols 410 resulting from the first outcome, while reels 408 that continue to spin did not include a cash on reel symbol 410 resulting from the first outcome. While one or more of the reels 408 are spinning, when the reel boost mechanic is initiated, a metamorphic feature animation may be displayed indicating to a player that the reel boost mechanic has been executed. In some embodiments, the metamorphic includes a graphic and/or an animation of Conan the Barbarian hitting the top of the reels 408 with a hammer, indicating to a player that Conan the Barbarian is altering an outcome of the remaining spinning reels 408. After the display screen displays the animation, one or more of the reels 408 stops moving.

In the example embodiment, the reels that are still spinning (i.e., reels two, four, and five) while the other reels one and three are stopped, indicate to the player that the reel boost mechanic is initiated. Specifically, in the embodiment of FIG. 4, the display of the spinning and stopped reels indicates that the spinning reels did not include a COR symbol in the initial outcome. In some embodiment, a rules engine of the gaming device 104 identifies in the background (i.e., without fully displaying the initial game outcome) that the reel boost mechanic is triggered since two of the three first columns included a COR symbol, determines whether to add any credit symbols to the columns, and causes display of the continued spinning reels in response to the determination. That is, in FIG. 4, the symbols of columns one and three are displayed to the user while the remaining columns are shown as still spinning.

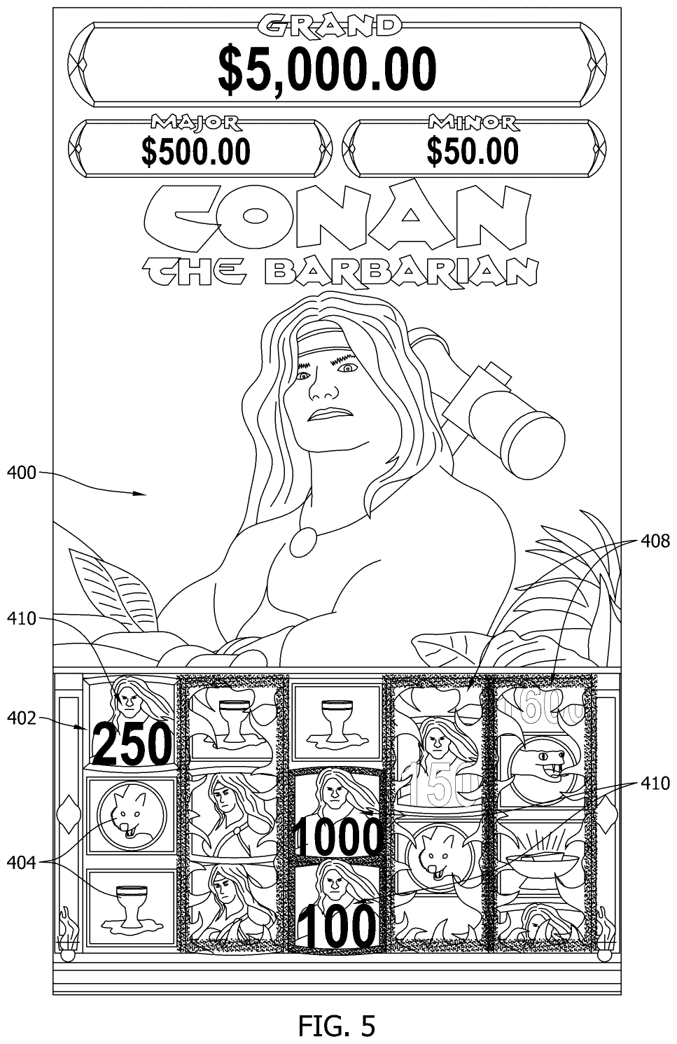

FIG. 5 displays a subsequent time during game play shown in FIG. 4, showing reels 408 one and three stopped and display cash on reel symbols 410, and reels 408 two, four, and five continue to spin, after reels 408 one and three have stopped. Stopped reels 408 one and three include one or more cash on reel symbols 410 having the potential to contribute to one or more paylines, e.g., when one or more of the spinning reels 408 are eventually stopped.

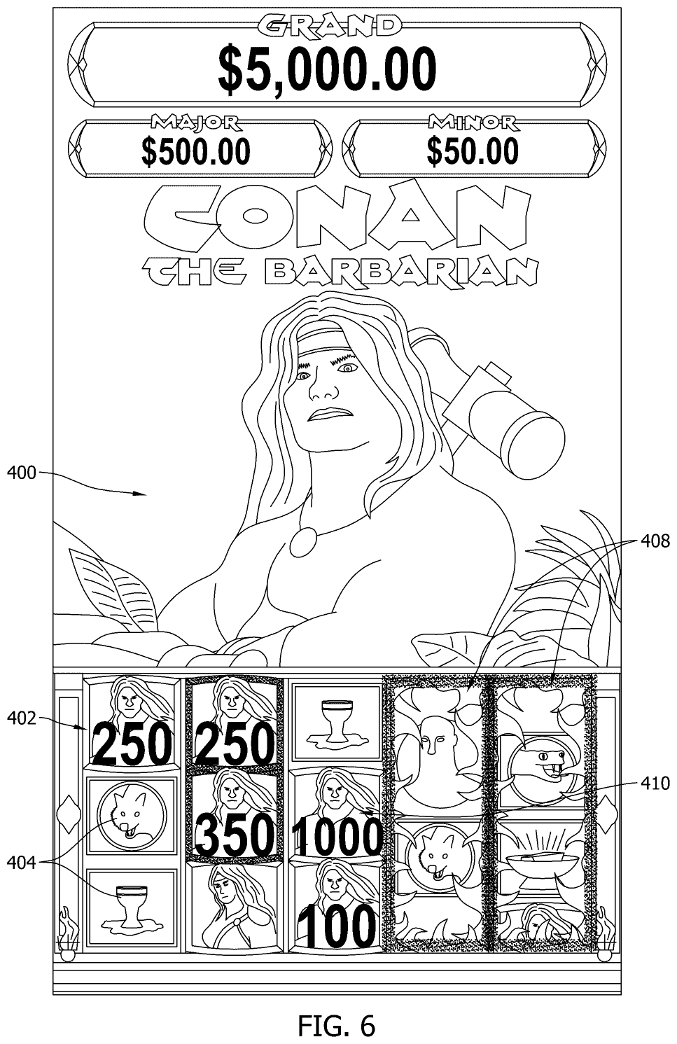

FIG. 6 illustrates a subsequent time during game play shown in FIGS. 4 and 5, showing reel 408 two stopped, in addition to reels 408 one and three which were previously stopped. The subsequently stopped reel 408 two includes one or more cash on reel symbols 410 that contribute to one or more paylines associated with cash on reel symbols 410 in the previously stopped reels 408 one and three. One or more of the other reels 408 may continue to spin, e.g., reels 408 four and five are still spinning. Iteratively stopping additional reels 408 builds anticipation for a player waiting to determine a game outcome.

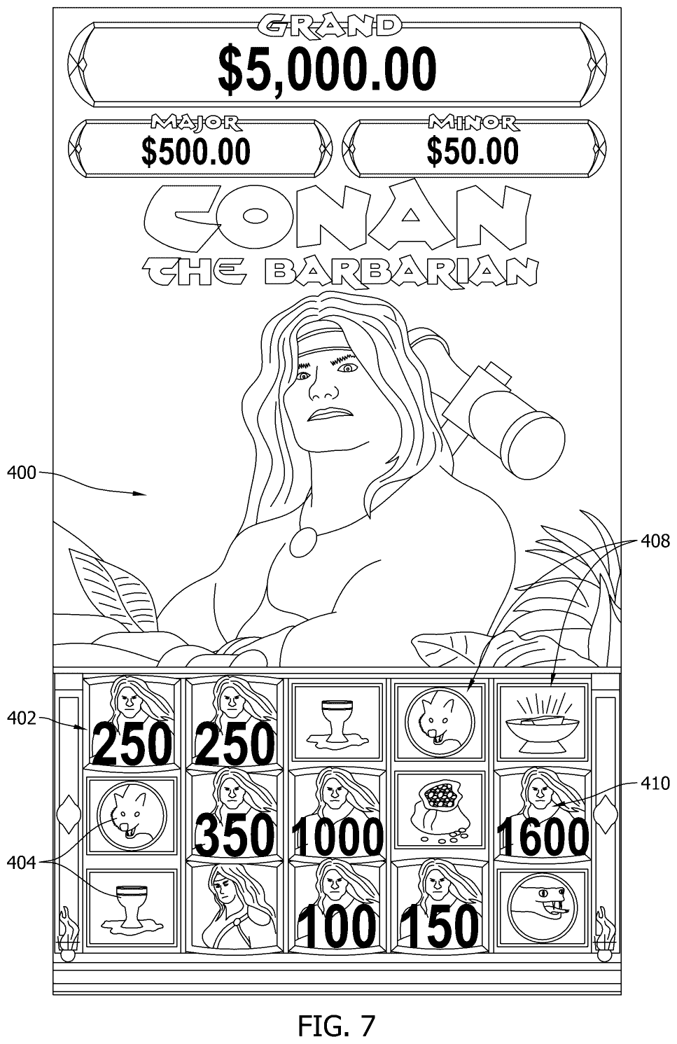

FIG. 7 illustrates a subsequent time during game play shown in FIGS. 4-6, showing reels 408 four and five stopped, in addition to reels 408 one, two, and three, which were previously stopped. The subsequently stopped reels 408 four and five include one or more cash on reel symbols 410 contributing to one or more paylines associated with cash on reel symbols 410 in the previously stopped reels 408 one, two, and three, thereby completing one or more paylines resulting in a winning combination resulting from execution of the reel boost mechanic.

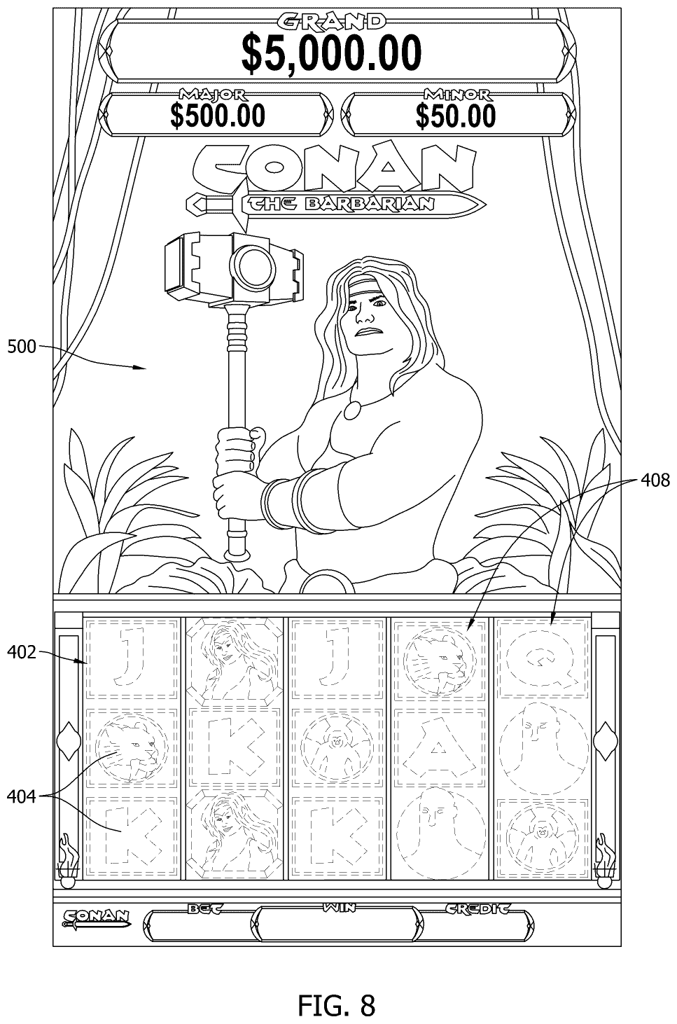

FIGS. 8-13 illustrates another example EGM screen 500 of a base game, which may be displayed on a display screen of an EGM (e.g., EGM 104) and may be controlled via, for example, a controller (e.g., game controller 202) that includes at least one processor in communication with at least one memory. EGM screen 500 may include one or more display components similar to EGM screen 400, e.g., EGM screen 500 includes a game play matrix display area 402 and a plurality of symbols 404 arranged in symbol positions within one or more of reels 408.

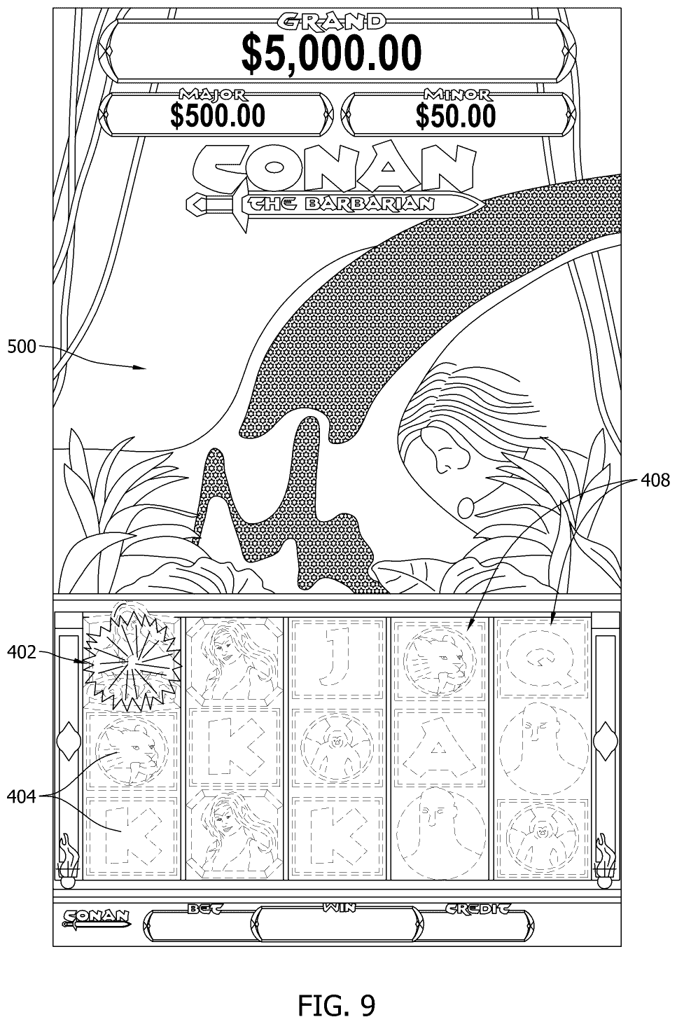

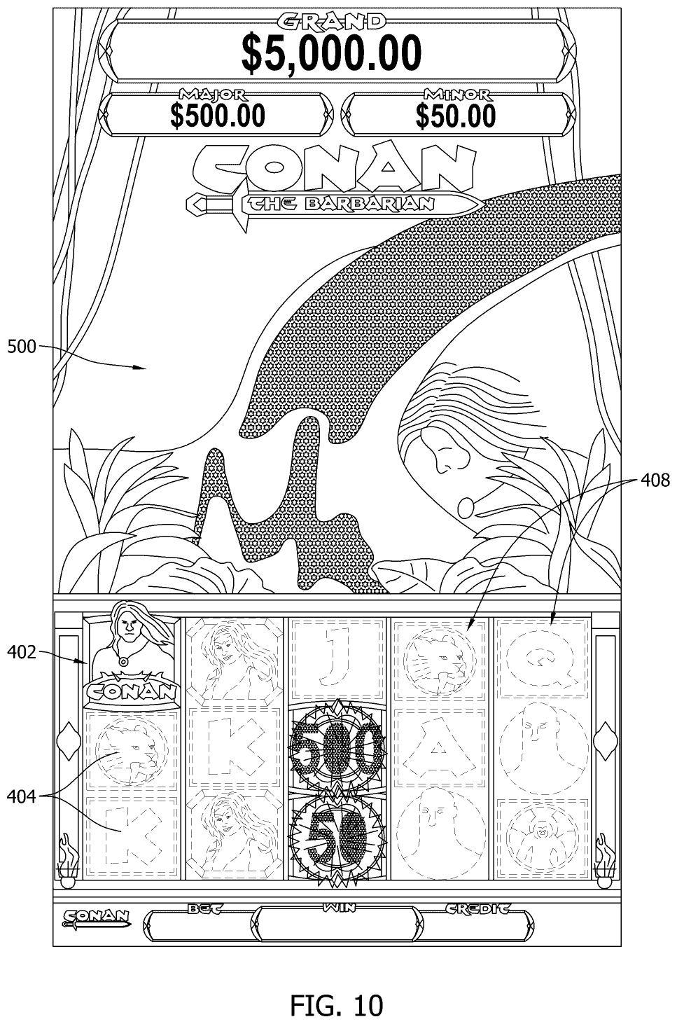

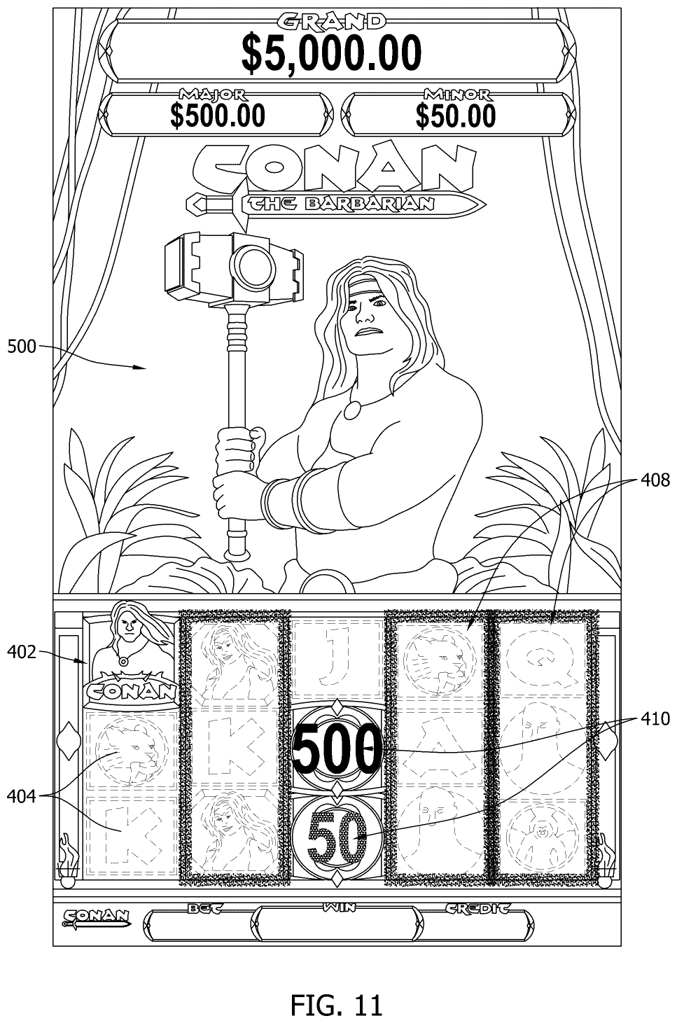

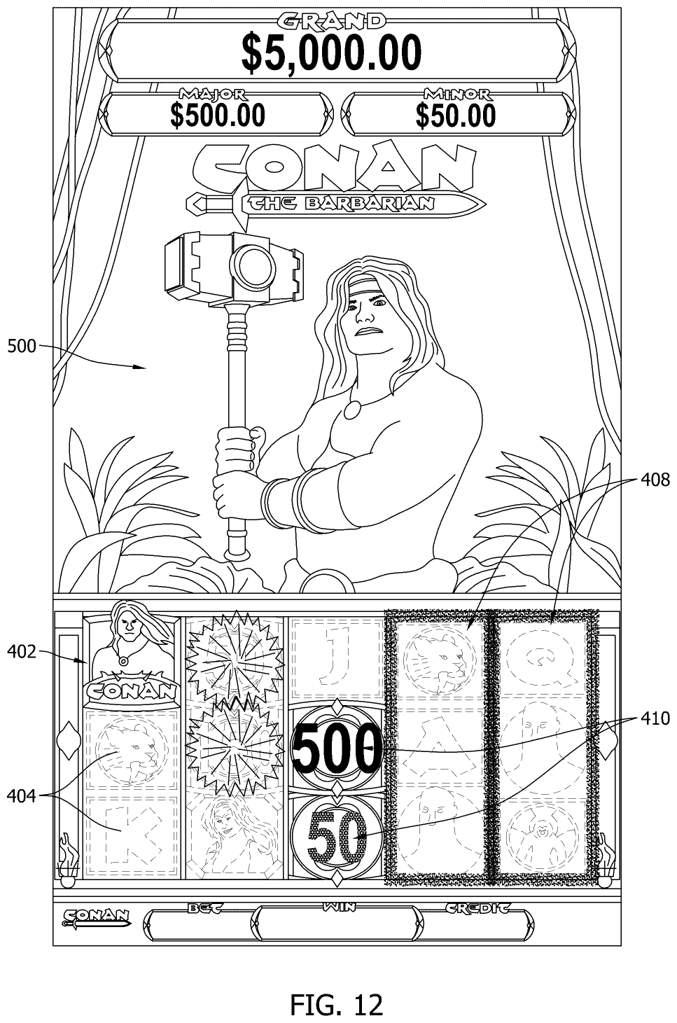

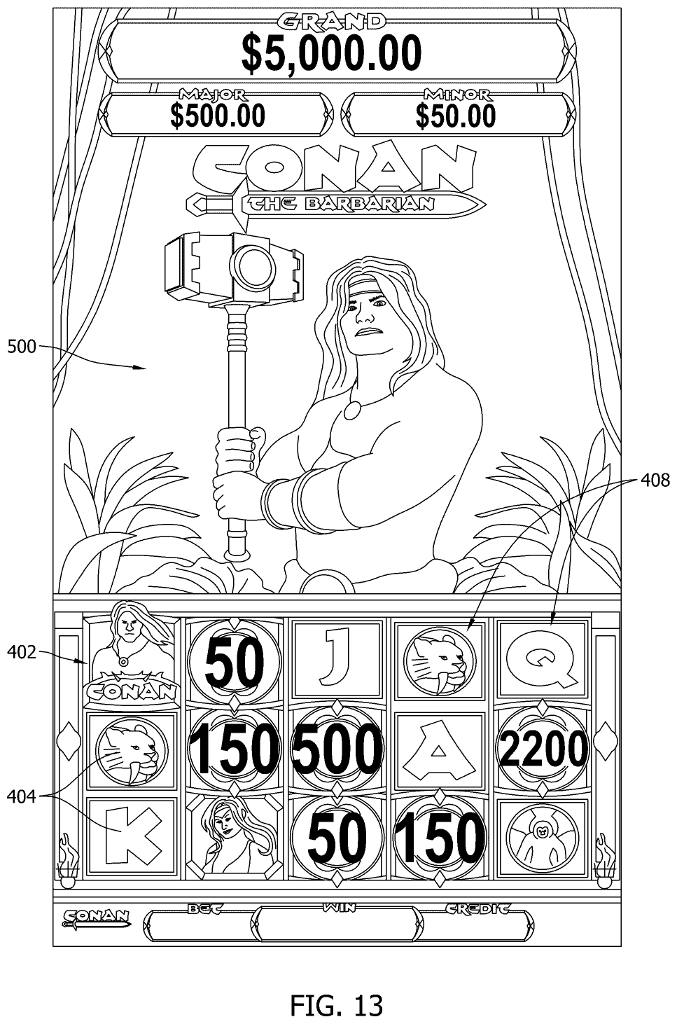

FIG. 8 shows all five of the reels 408 spinning, e.g., after a turn of gameplay. In reference to FIGS. 9-10, the reel boost mechanic has been completed, e.g., a trigger condition was satisfied, the reel boost mechanic was executed on one or more reels 408 and the reel boost mechanic was successful, resulting in a second outcome including a winning combination. FIGS. 9-10 shows an animation of the metamorphic feature animation including a character, Conan the Barbarian, striking a top of the reels 408. In reference to FIGS. 10-11, reels 408 one and two have been stopped, wherein reel 408 one includes a Conan symbol and reel 408 two includes cash on reel symbols 410. FIGS. 12 and 13 show the stopping of the remaining reels two, four, and five.

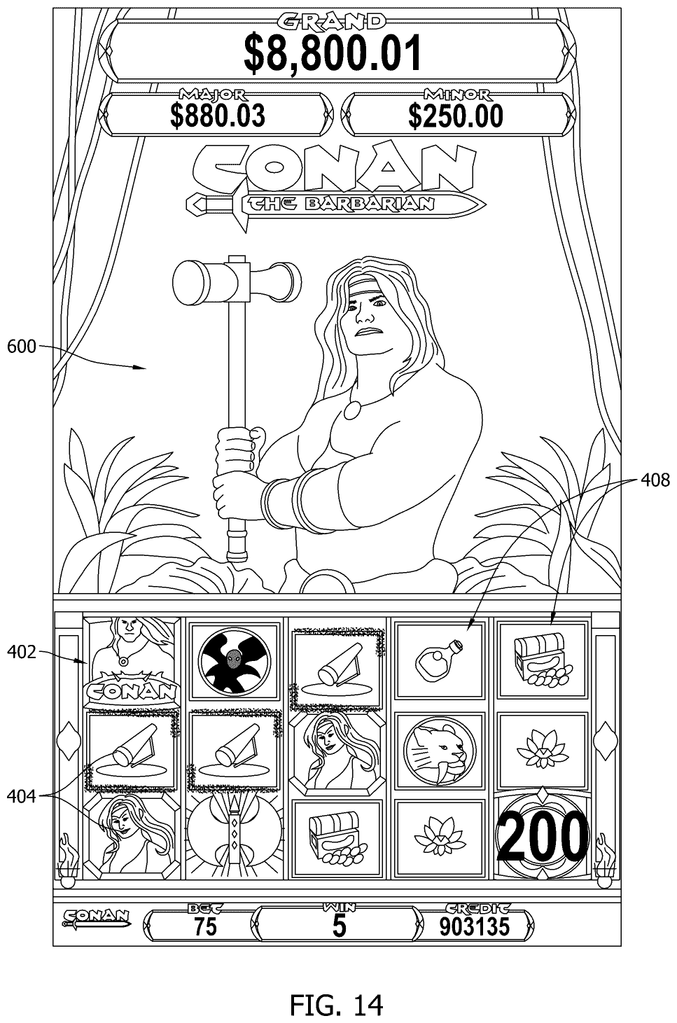

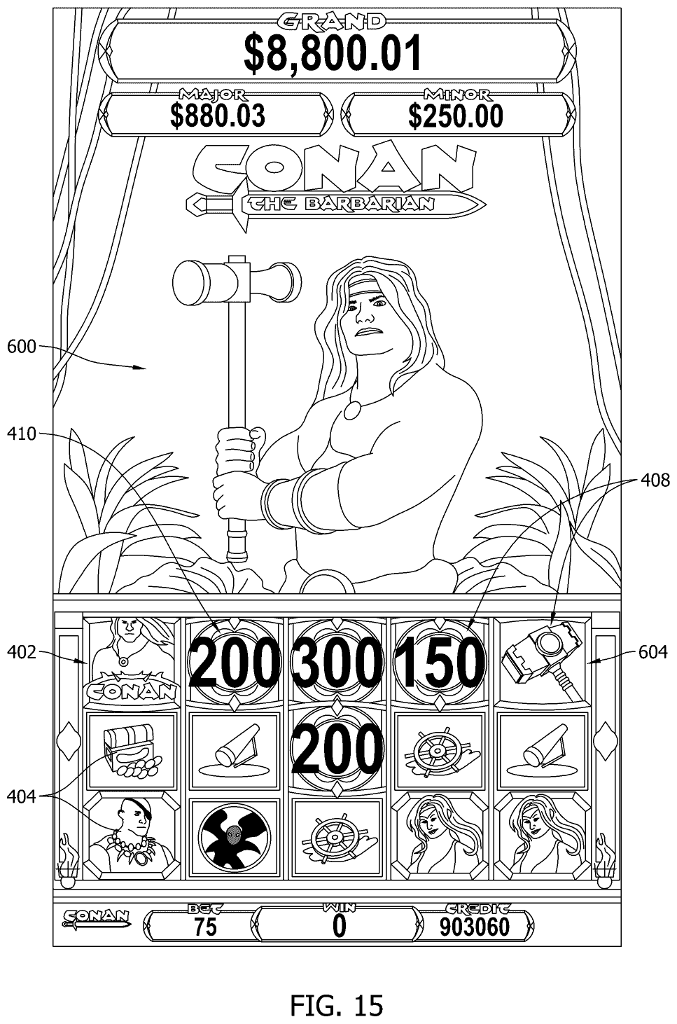

FIGS. 14-15 illustrates another example EGM screen 600 of a base game, which may be displayed on a display screen of an EGM (e.g., EGM 104) and may be controlled via, for example, a controller (e.g., game controller 202) that includes at least one processor in communication with at least one memory. EGM screen 600 includes one or more display components similar to EGM screen 400, e.g., EGM screen having the game play matrix display area 402 and a plurality of symbols 404 arranged in symbol positions within one or more of reels 408. FIG. 15 shows all five reels 408 stopped, with reel 408 five including a cash on reel symbol 410.

FIG. 15 illustrates the EGM screen 600 of a base game, which may be displayed on a display screen of an EGM (e.g., EGM 104) and may be controlled via, for example, a controller (e.g., game controller 202) that includes at least one processor in communication with at least one memory. FIG. 15 shows all five reels 408 stopped, with reels 408 two, three, and four, including cash on reel symbols 410 and reel 408 five showing the hammer feature symbol 604. The hammer feature symbol 604 indicates to a player that a bonus game has been triggered. In some embodiments, the hammer feature symbol 704 may only be displayed on an end reel 408 or a final reel 408 on a right side. In the illustrated embodiment, the hammer feature symbol 604 is displayed on reel 408 five.

In some embodiments described herein, the reel boost mechanic is associated with a subsequent RNG output that is generated after a first outcome, providing players an opportunity to boost, e.g., change, a losing symbol combination to a winning symbol combination, as described herein. In particular, the reel boost mechanic may be triggered after a first outcome does not include the predetermined number and/or pattern of cash on reel symbols, and whereby executing the reel boost mechanic provides an additional opportunity to change the first outcome to include the predetermined number and/or pattern of cash on reel symbols 410. The reel boost mechanic, if successful, adds one or more cash on reel symbols 410 to a reel 408 that previously did not include a cash on reel symbol 410 or did not previously contain a cash on reel symbol 410 positioned along a payline resulting from a first RNG output. In some embodiments, an indication that the reel boost mechanic has been executed occurs, if, and only if, the reel boost mechanic results in a winning combination.

The reel boost mechanic includes a plurality of lookup tables that are stored on the memory 208. Each of the lookup tables are associated with a corresponding one of the reels 408 and include weighted probabilities that are used to determine whether to add any cash on reel symbols 410 to a given reel 408 and how many symbols should be added. The weighted probabilities for each of the lookup tables may be different to provide improved control and variability over the determinations for adding cash on reel symbols 410 to a given column. In some embodiments, each of the tables include a listing of how many cash on reel symbols 410 to add, ranging from zero to three, and a listing of probabilities corresponding to the listings for the number of symbols to add. As one non-limiting example, a first lookup table associated with the first reel 408 may include a twenty percent probability of adding zero cash on reel symbols 410, a forty percent probability of adding one cash on reel symbol 410, a twenty-five percent probability of adding two cash on reel symbols 410, and a fifteen percent probability of adding three cash on reel symbols 410. Additionally, a second lookup table associated with the second reel 408 may include different probabilities for one or more of the listings of cash on reel symbols 410 to be added from the first lookup table.

In some embodiments, the reel boost mechanic may be executed, after the first losing outcome, resulting in the second outcome including a losing outcome, e.g., the reel boost mechanic was unable to change the result of the first outcome to include the predetermined number and/or pattern of cash on reel symbols 410. In some embodiments, the display screen only displays the metamorphic graphic if the secondary outcome includes a winning outcome. For example, if the reel boost mechanic did not result in the second outcome being different from the first outcome, the player may not be alerted that the reel boost mechanic was executed.

In some embodiments, the reel boost mechanic may be applied to each reel 408 individually and separately. In some embodiments, the reel boost mechanic may be applied to reels 408 sequentially left to right. The reel boost mechanic may be sequentially applied to reels 408 from left to right, but the reel boost mechanic may be halted from executing on subsequent reels 408, in the event that the reel boost mechanic failed to change a prior reel 408 to include one or more cash on reel symbols 410 contributing to one or more paylines associated with cash on reel symbols 410 in the previous reels 408.

The reel boost mechanic may be initiated based on one or more trigger conditions being satisfied. Trigger conditions may include a first outcome failing to include the predetermined number and/or pattern of cash on reel symbols 410. Trigger conditions may also include an outcome that is close to including the predetermined number and/or pattern of cash on reel symbols 410, such as where two or more reels 408 having cash on reel symbols 410 having the potential to contribute to one or more paylines. For example, EGM 104 may be a gaming device having a winning outcome including a three of a kind pattern, e.g., wherein three reels 408 (e.g., reels 408 one, two, and three from left towards the right) have a cash on reel symbols 410 aligned with a payline. If the first game outcome, including a losing outcome, is such that reels 408 one and three including a two of a kind pattern, having cash on reel symbols 410 aligned with a payline, but reels 408 two, four, and five, do not have a cash on reel symbol 410 and/or do not contribute to a payline. The two of a kind outcome may be a trigger condition for execution of the reel boost mechanic. In this example, the reel boost mechanic may be executed on reels 408 three, then subsequently on reel 408 four, and then subsequently on reel 408 five. In this example, the reel boost mechanic may be executed on reels 408 from left to right, provided the executing of the reel boost mechanic on a prior reel 408 was successful in generating a cash on reel 408 contributing to the paylines associated with reels 408 one and three.

The reel boost mechanic may be executed on either, or both, of a base game and a bonus game. In some embodiments, the reel boost mechanic may be executed more frequently on the bonus game. In some embodiments, a reel boost mechanic, resulting in a winning outcome, may initiate the bonus game.

A winning combination may refer to a three combination (e.g., three cash on reel symbols 410 aligned on a payline), a four combination, or a five combination. Accordingly, the indication to the player that the reel boost mechanic has been executed, may indicate that the result is a winning combination, however, the final awarded amount, based on the number combination, is delayed, building anticipation for players. The delay, and associated anticipation of the player, in showing the final winning amount and number of cash on reel symbols 410 combination, is implemented by continuing to spin one or more reels 408, while holding one or more reels 408 in the stopped position. For example, amounts may be awarded based on the number of cash on reel symbols 410 aligned on a payline, wherein a payout amount may increase with an increase in the number of cash on reel symbols 410 positioned on a payline. For example, four cash on reel symbols 410 positioned on a payline may result in a payment amount that is greater than a payment amount for three cash on reel symbols 410 positioned on a payline.

In some embodiments, when the final reel 408, e.g., reel 408 five, is not boosted by the reel boost mechanic, rather, a value is drawn to determine if a bonus game is executed and a hammer symbol is displayed.

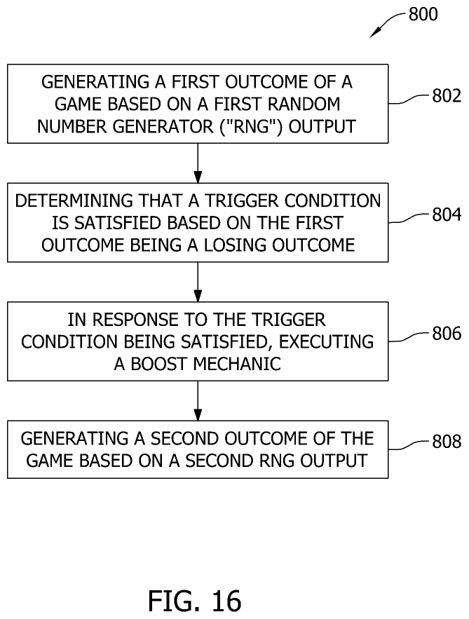

FIG. 16 is a flow diagram of an exemplary method 800 of conducting a boosting mechanic on an electronic gaming machine, such as, for example, electronic gaming machine 400, 500, and 600, as shown in FIGS. 4-15.

Method 800 includes generating 802 a first outcome. The first outcome including a plurality of symbols positioned in a plurality of reels. Generating 802 a first outcome may be based on a first random number generator (“RNG”) output. Generating 802 a first outcome may include executing an RNG for each reel 408 and/or performing a lookup from a lookup table to determine how many cash on reel symbols 410 will be awarded on each of the reels 408. Generating 802 a first outcome may include one or more additional and/or alternative step necessary in generating a first outcome including at least one of a winning combination or losing combination, resultant from the executed RNG and/or performed lookup for each reel 408.

Method 800 includes determining 804 if one or more trigger conditions have been satisfied, for determining if the reel boost mechanic should be executed. A first trigger condition includes determining that the first outcome is a losing outcome. A second trigger condition includes determining that the first outcome is within a predefined range of the predetermined number and/or pattern of cash on reel symbols 410, e.g., two or more reels 408 have cash on reel symbols 410 having the potential to contribute to one or more paylines across all five reels 408. In some embodiments, the second trigger condition may include determining that center reels 408, e.g., reels 408 two, three, and four, do not contain cash on reel symbols 410, but end reels 408, e.g., reels 408 one and five, include cash on reel symbols 410 having the potential to contribute to one or more paylines including the middle reels 408. A third trigger condition may include drawing a value from a weighted table to determine if the reel boost mechanic should be executed. The third trigger condition may include drawing a binary value, e.g., yes, or no, from the weighted table to determine if the reel boost mechanic feature should be executed.

Determining 804 may include determining if the first trigger condition is satisfied, and then subsequently determining if the second trigger condition is satisfied. Determining 804 may include determining that the second trigger condition is satisfied, only if the first trigger condition has been satisfied. For example, the second trigger condition is not checked, if the first trigger condition is not satisfied. Determining 804 may include determining if the third trigger condition has been satisfied. Determining 804 may include determining if each of the first trigger condition, the second trigger condition, and the third trigger condition have each been satisfied.

Responsive to determining 804 the trigger conditions have been satisfied, method 800 includes executing 806 the reel boost mechanic on one or more reels 408. Executing 806 the reel boost mechanic feature includes individually executing the reel boost mechanic on a single reel. Executing 806 the reel boost mechanic may include drawing a value from a weighted table to determine a number of cash on reel symbols 410 to populate on a reel 408. Drawing a value from the weight table may result in a value of 0, 1, 2, or 3, indicative of a number of cash on reel symbols 410 to be populated on the reel 408.

In some embodiments, executing 806 the reel boost mechanic includes identifying a first reel that does not include a first symbol type associated with a winning outcome. Executing 806 the reel boost mechanic includes generating 808 a second outcome of the game based on a second RNG output. The second outcome including a different set of symbols in the first reel based on the second RNG output, executing 806 the reel boost mechanic includes determining whether the second outcome is a winning outcome based on whether the second outcome includes a symbol of the first symbol type in the first reel.

Executing 806 the reel boost mechanic on one or more reels 408 may include executing the reel boost mechanic on reels 408 that did not previously contain cash on reel symbols 410 resultant from the first outcome. For example, if the middle reels 408, e.g., reels 408 two, three, and four, previously did not contain cash on reel symbols 410, the reel boost mechanic may be executed on each of the middle reels 408, individually. Executing 806 may include executing the reel boost mechanic individually on each reel 408, individually, and in order from left to right. If the reel boost mechanic fails to generate a cash on reel symbol 410 on a reel 408, the reel boost mechanic will not be executed on subsequent reels 408.

Responsive to the executing the reel boost mechanic generating a second outcome including a winning outcome, display the winning combination. In some embodiments, method 800 include displaying the metamorphic feature on a display, e.g., the main display 128, responsive to the second outcome including a winning outcome. Method 800 may include displaying the metamorphic feature, if and only if, executing of the reel boost mechanic results in a second outcome that is a winning outcome. For example, if execution of the reel boost mechanic results in a losing outcome, e.g., the reel boost mechanic failed to change the first outcome of a losing outcome, the game and the player are not interrupted.

Method 800 may include displaying spinning reels 408 and stopped reels 408, prior to displaying the metamorphic feature. Method 800 may include stopping one or more reels 408 which include cash on reel symbols 410 resulting from the first game outcome, while one or more reels 408 are spinning which did not include cash on reel symbols 410 resulting from the first game outcome. Displaying the metamorphic feature may include a graphic that contact, e.g., hammers or touches etc., one or more of the spinning reels 408, providing an indication that the metamorphic feature will alter a losing outcome and result in a winning outcome.

Method 800 may include determining that a bonus game trigger condition is satisfied and, in response to the bonus trigger condition being satisfied, randomly determining, if a bonus game should be initiated. In some embodiments, the bonus game trigger is the same as one or more of the first, second and/or third trigger, described above. In some embodiments, determining a bonus game trigger condition may include, for a final reel, drawing a binary value from a lookup table, wherein the binary value includes a yes or no, wherein the yes cause the bonus game to be triggered and causes the final reel 408 to display a hammer symbol, indicating to a player that the bonus game has been triggered.

Method 800 may include executing the reel boost mechanic during the bonus game, in a similar manner, as executing the reel boost mechanic executed during the base game.

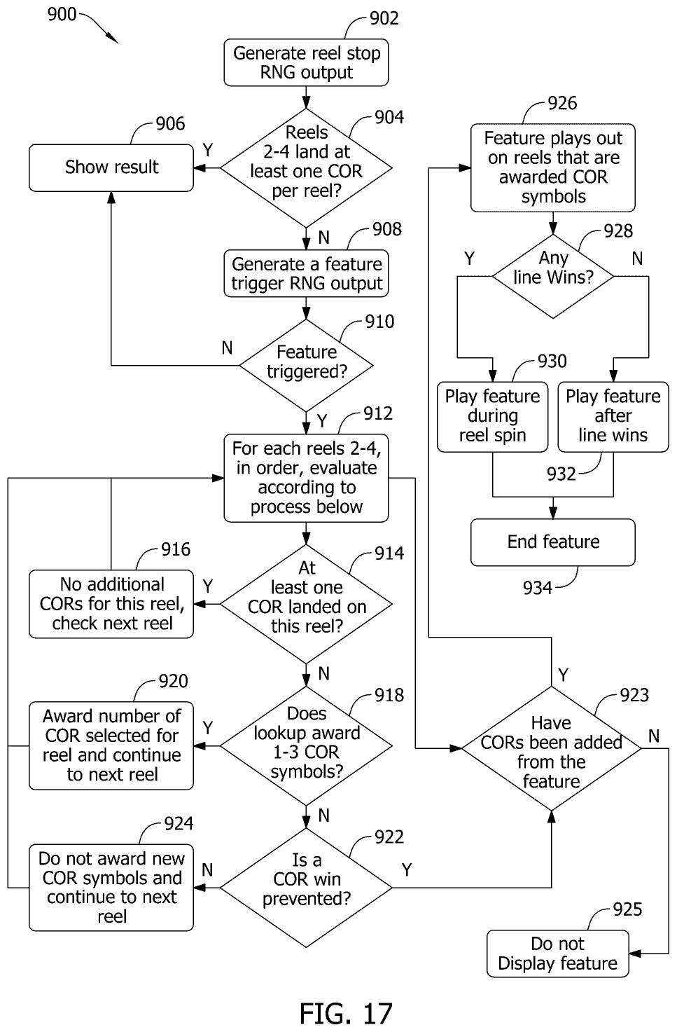

FIG. 17 is another flow diagram of an exemplary process 900 of conducting a boosting mechanic on an electronic gaming machine, such as, for example, electronic gaming machine 400, 500, and 600, as shown in FIGS. 4-15.

Process 900 includes a step 902 of generating a reel stop RNG output. The reel stop RNG output is used to determine the first outcome of a game instance (i.e., an initial plurality of symbols positioned in a plurality of reels). At step 904, a determination is made as to whether one or more reels (reels 2-4 in the example embodiment) include at least one COR symbol on each of the reels. If each of reels 2-4 include at least one COR symbol, process proceeds to step 906, in which the first outcome is displayed and the reel boost mechanic is not executed. If reels 2-4 do not each include at least one COR symbol, process proceeds to step 908, at which a feature trigger RNG output is generated. The RNG output of step 908 is used to determine whether the feature (i.e., the reel boost mechanic) is triggered at step 910, such as by performing a lookup of one or more weighted tables using the feature trigger RNG output. If it is determined that the feature is not triggered at step 910, process 900 proceeds to step 906, in which the first outcome is displayed and the reel boost mechanic is not executed. If the feature is triggered at step 910, process 900 proceeds to step 912.

At step 912, each reel of the one or more reels (reels 2-4 in the example embodiment) is evaluated in order. In the example embodiment, the reel boost mechanic may only be applied to reels 2-4, though in other embodiments, the reel boost mechanic may be applied to any combination of one or more of the reels. At step 914, a determination is made whether the reel includes at least one COR symbol landed in the first outcome. For example, where none of reels 2-4 include a COR symbol, reel 2 (i.e., the leftmost reel of reels 2-4) is first evaluated. If reel 2 includes a COR symbol in the first outcome, process proceeds to step 916, in which no additional COR symbols are added to reel 2 and step 914 is repeated for the next reel (e.g., reel 3). If reel 2 does not include a COR symbol, process 900 proceeds to step 918.

At step 918, a determination is made as to whether a lookup awards COR symbols to the reel and how many COR symbols are awarded. In the example embodiment, the lookup is performed using an RNG output and a lookup table that is associated with the reel. The lookup table includes a column of weighted probabilities and a column of entries indicating how many COR symbols are to be added (e.g., 0, 1, 2, and 3). In other embodiments, more than one lookup may be performed to determine how many COR symbols to add to the reel. For example, in one embodiment a first lookup is performed to determine whether to add any COR symbols to the reel and, if it is determined based on the first lookup to add COR symbols to the reel, a second lookup is performed to determine how many COR symbols should be added to the reel.

If it is determined based on the lookup to award at least one COR symbol to the reel, in other words (i.e., the lookup returned a value greater than one in the example embodiment) process 900 proceeds to step 920 in which the number of selected COR symbols are awarded and the process 900 continues to evaluation of the next reel. If it is determined from the lookup that no additional COR symbols are awarded at step 918, process 900 proceeds to step 922.

At step 922 a determination is made as to whether a COR win is prevented based on the decision that no additional COR symbols are awarded to the reel. If a winning combination of COR symbols is not prevented, the process 900 proceeds to step 924, in which no added COR symbols are awarded for the reel and the process 900 continues to evaluate the next reel. After all reels (e.g., reels 2-4 in the example embodiment) are evaluated, process proceeds to step 923. Alternatively, at step 922, if it is determined that a COR win is prevented based on the decision that no additional COR symbols are awarded to the reel, the process 900 proceeds to step 923.

At step 923, a determination is made as to whether COR symbols have been added to the outcome based on the feature. If no COR symbols have been added from the feature, the process 900 proceeds to step 925. At step 925, execution of the feature is ended and the feature is not displayed on the display screen. In some embodiments, at step 923, the determination is based on whether a winning combination of COR symbols is awarded from the reel boost mechanic. That is, even if one or more COR symbols are added from the reel boost mechanic, the reel boost mechanic is not displayed and the spin ends with display of the initial outcome if the added COR symbols do not result in a winning combination. In the example embodiment, COR symbols in at least the second reel are required for a winning combination of COR symbols. Where the reel boost mechanic does result in awarding of COR symbols having a winning combination, the process 600 proceeds to step 926 for displaying the added COR symbols in the matrix of symbol positions.

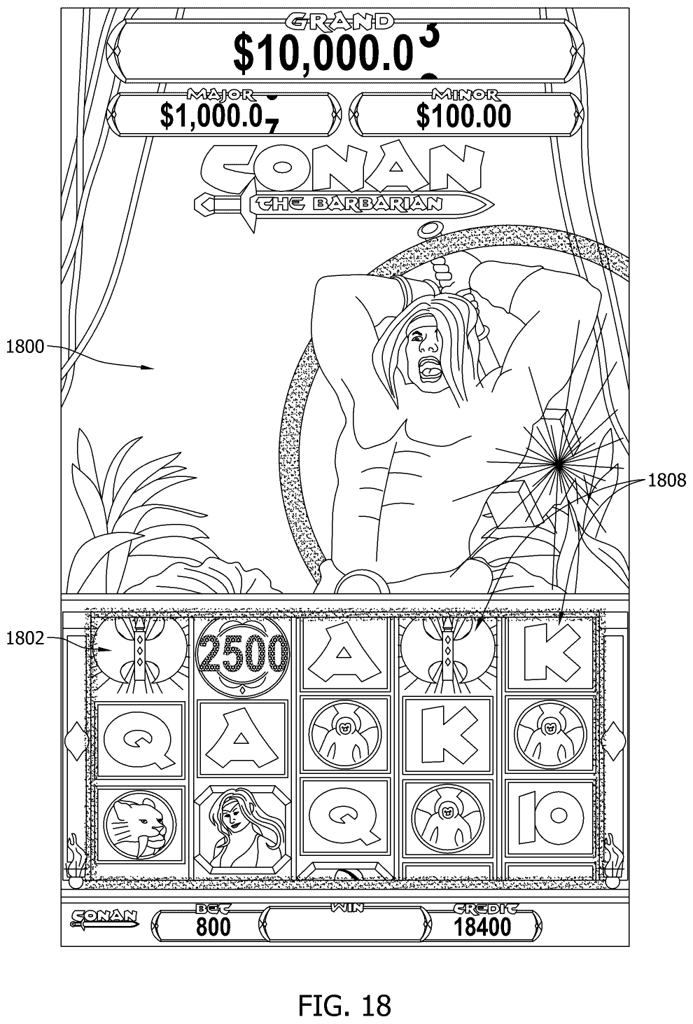

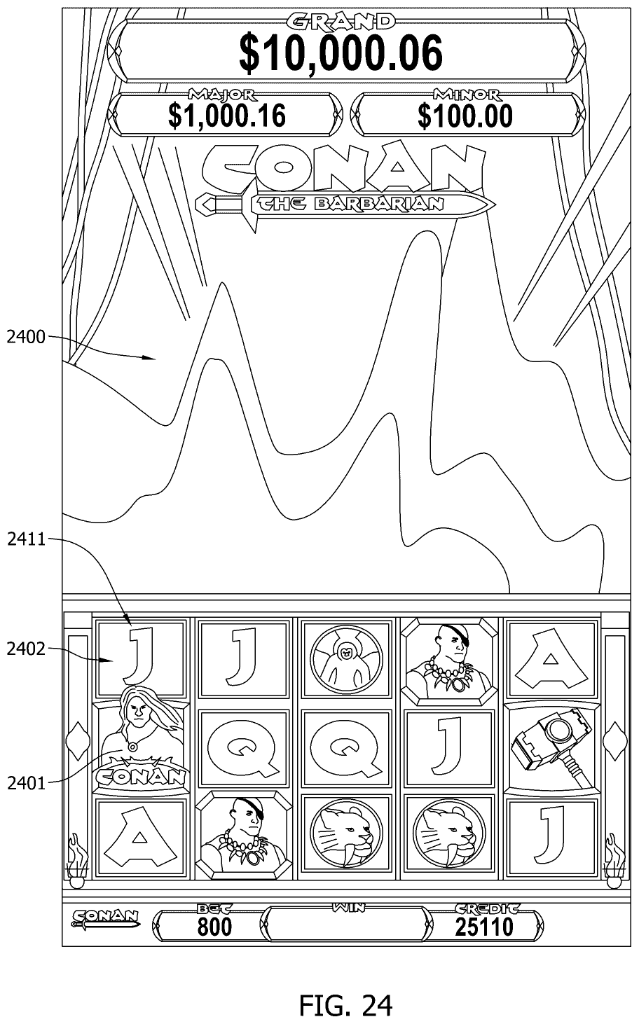

At step 926, the reel boost mechanic is applied to reels that are awarded COR symbols. At step 928, a determination is made as to whether any line wins, such as winning combinations of other symbols in the symbol positions, occur in the game outcome (e.g., the first game outcome). If the first outcome does not include line wins, process 900 proceeds to step 932, and the reel boost mechanic is displayed after the first outcome of the game is initially displayed, similar to the example shown in FIGS. 24-28. If the first outcome does include line wins, process 900 proceeds to step 930, in which the reel boost mechanic is displayed during the reel spin (i.e., while the reels are spinning and prior to displaying the first game outcome), similar to the example shown in FIGS. 18-23. After the second outcome is displayed in conjunction with the reel boost mechanic, the feature is ended at step 934. In some embodiments, if there are no line wins at step 928, the feature may be displayed during reel spin (e.g., step 930) or may display after line wins are initially displayed (e.g., step 932) based on one or more lookups of a weighted table using an RNG output.

In some embodiments, after it is determined how many COR symbols are awarded in the second game outcome, independent RNG outputs and lookups of weighted tables are used to determine the credit values of COR symbols. In one embodiment, lookup tables for COR values are provided for each reel and a lookup is performed for each COR symbol occurring in the second outcome.

FIGS. 18-23 illustrate an example EGM screen 1800 of a base game, which may be displayed on a display screen of an EGM (e.g., EGM 104) and may be controlled via, for example, a controller (e.g., game controller 202) that includes at least one processor in communication with at least one memory. In particular, FIGS. 18-23 illustrate a display of base game according to step 932, in which the reel boost mechanic is provided while the reels 1808 are spinning. As shown in FIG. 18, an indication of the reel boost mechanic being displayed is provided by the metamorphic feature animation on the display 1800, specifically of the Conan the Barbarian hitting the matrix 1802 with the hammer.

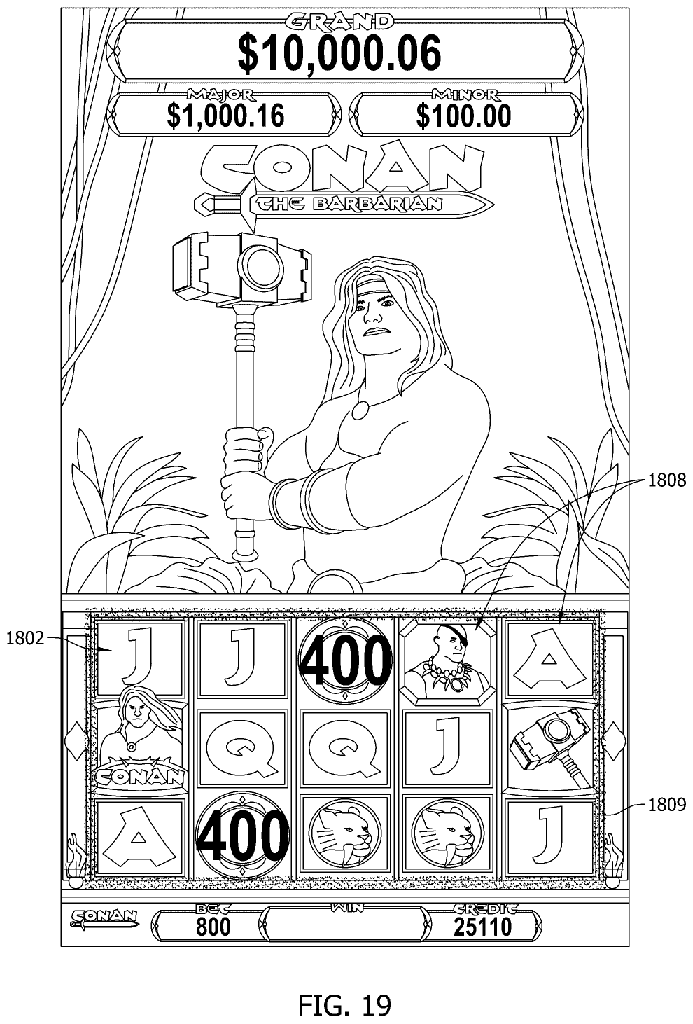

FIG. 19 shows a subsequent time during game play shown in FIG. 18, during which each of the reels 1808 are spinning. In the embodiment of FIG. 19, after display of the reel boost is initiated, and specifically after display of the metamorphic feature animation, an anticipation effect 1809 is displayed on the matrix 1802. In the example, the anticipation effect 1809 is a blue flame that extends around a perimeter of the matrix 1802. The anticipation effect 1809 indicates that one or more of the reels 1808 are in the process of being “boosted” by adding one or more COR symbols to the reels 1808. The embodiments of FIGS. 18-23 and FIGS. 24-28 differs from the embodiment of FIGS. 5-15, in that the anticipation effect 1809 is applied to the entire matrix 1802, and not just to the reels that are being boosted by adding one or more additional COR symbols, as shown in FIG. 5 for example. In other embodiments, any one of the anticipation effect of FIGS. 5-15 and 18-28 may be used with any of the other embodiments described herein.

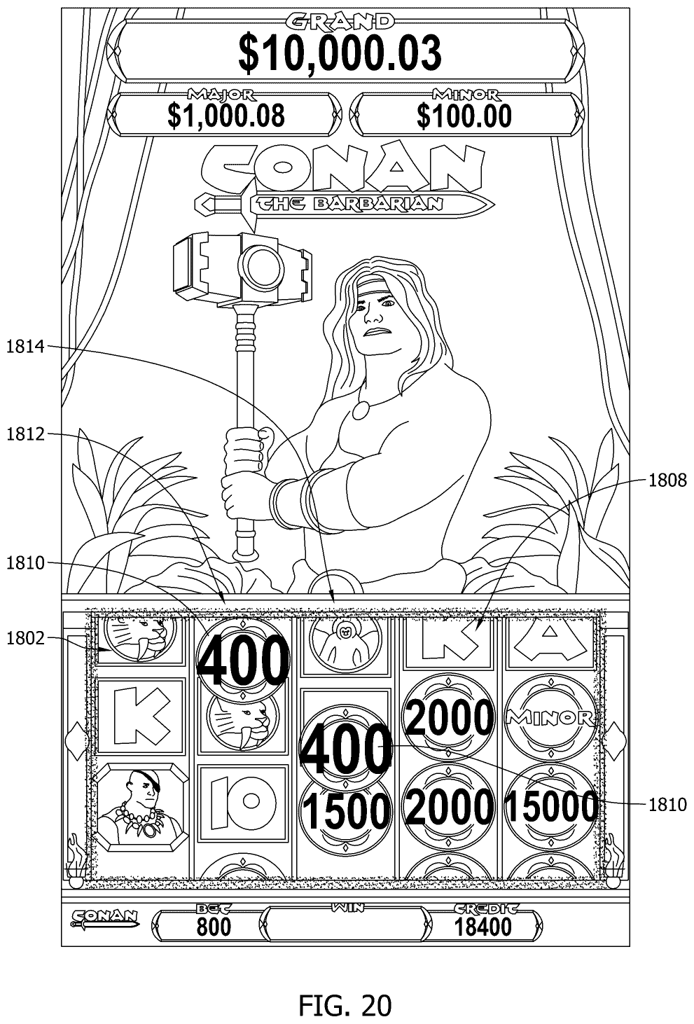

FIG. 20 shows a subsequent time during game play shown in FIG. 19, during which two new COR symbols 1810 are added to the matrix 1802, and specifically, to the second reel 1812 and the third reel 1814. As shown in FIG. 20, the new COR symbols 1810 are displayed as overlay symbols, overlaying the spinning underlying reels 1808. In the example embodiment, each of the reels 1808 continue to spin and any new COR symbols 1810 are added individually added to the matrix 1802 in order of increasing credit values of the COR symbols 1810, though in other embodiments, the new COR symbols 1810 may be added in any suitable order (e.g., in order of reel and/or in order of row, etc.).

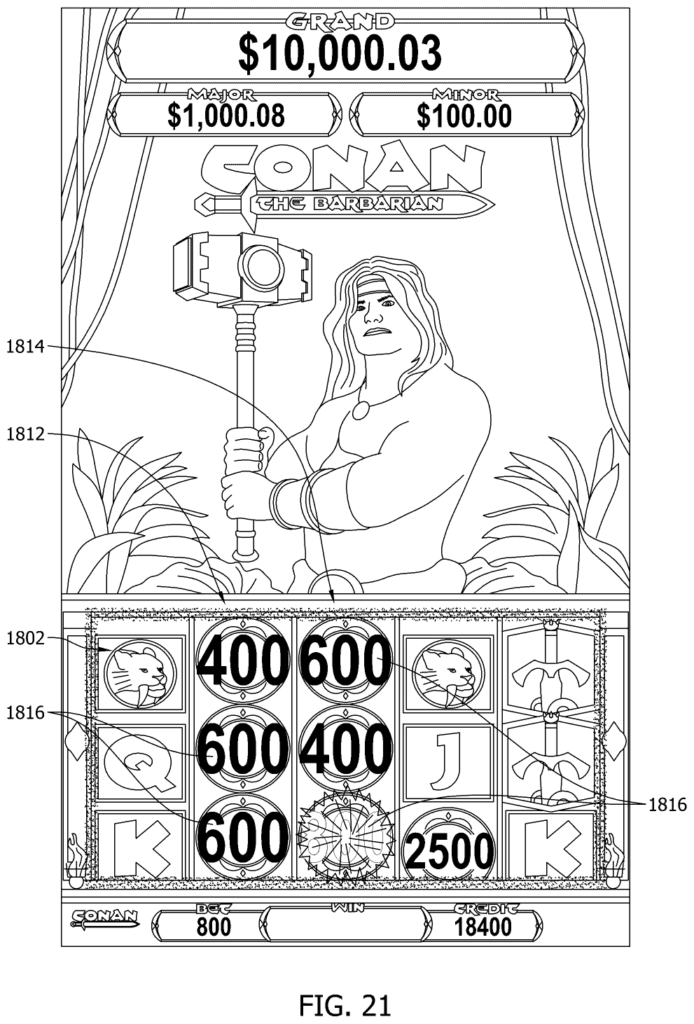

FIG. 21 shows a subsequent time during game play shown in FIG. 20, during which additional new COR symbols 1816 are added to the 1802. As shown in FIG. 21, a total of three new COR symbols 1816 are added to each of the second and third reels 1812, 1814.

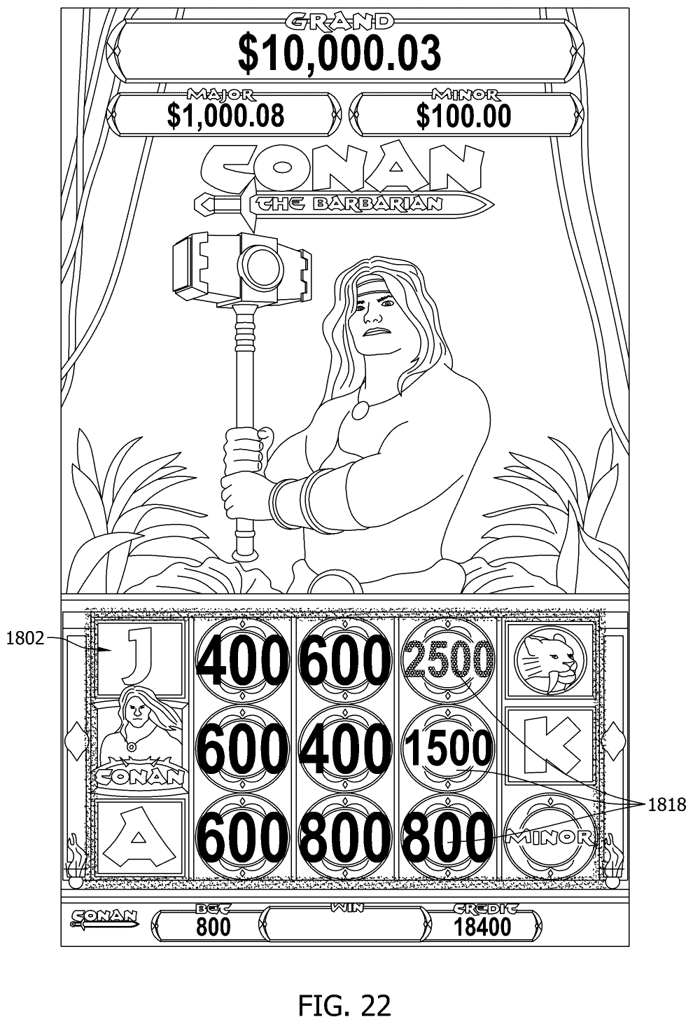

FIG. 22 shows a subsequent time during game play shown in FIG. 21, during which all remaining new COR symbols 1818 are added to the matrix 1802. As shown in FIG. 22, each of reels 2-4 include three COR symbols 1818 added by execution of the reel boost mechanic. Additionally, all new COR symbols 1818 were revealed during game play in order of ascending credit value, and subsequently ascending reel for symbols having equal credit values.

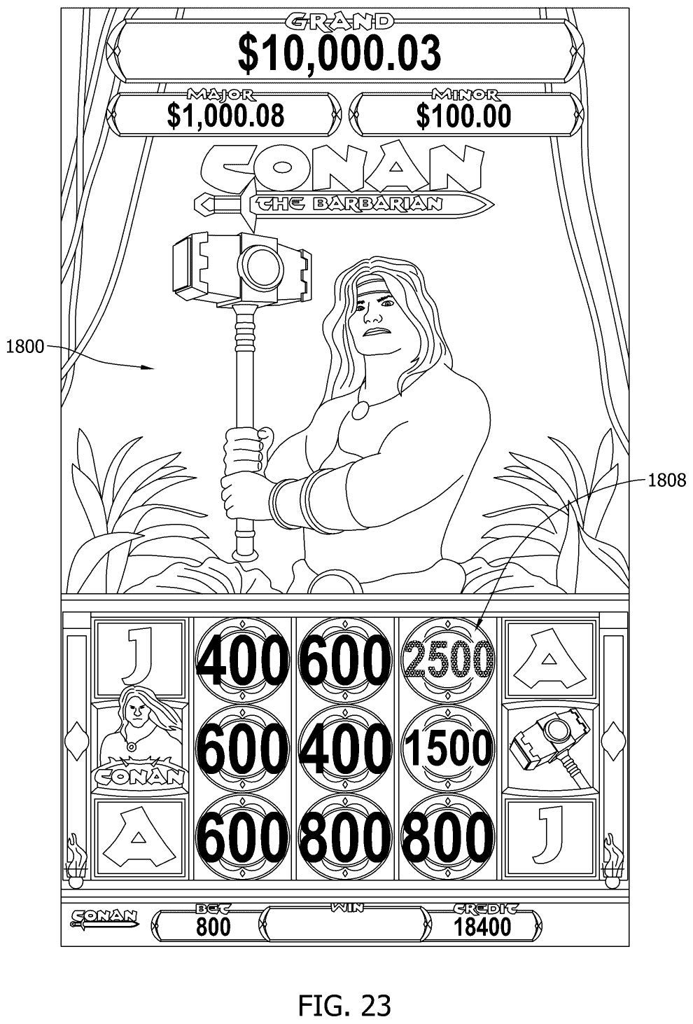

FIG. 23 shows a subsequent time during game play shown in FIG. 22, during which all new COR symbols have been added and reels 1808 have stopped spinning, displaying the second and final outcome of the game. As shown in FIG. 23, the anticipation effect 1809 (shown in FIG. 19) is removed from the display 1800.

FIGS. 24-28 illustrate an example EGM screen 2400 of a base game, which may be displayed on a display screen of an EGM (e.g., EGM 104) and may be controlled via, for example, a controller (e.g., game controller 202) that includes at least one processor in communication with at least one memory. In particular, FIGS. 18-23 illustrate a display of base game according to step 930, in which the reel boost mechanic is provided after the reels have stopped spinning and the initial outcome is displayed.

Referring to FIG. 24, an indication of the reel boost mechanic being displayed is provided by the metamorphic feature animation on the display 2400, specifically of the Conan the Barbarian hitting the matrix 2402 with the hammer, after the reels have stopped spinning and the initial outcome is displayed. In the example embodiment, a trigger symbol 2401 is provided on the first reel 2411 in the initial outcome, which evaluates as a COR symbol for purposes of triggering the reel boost mechanic. In the example of FIG. 24, no other COR symbols are provided in the first game outcome.

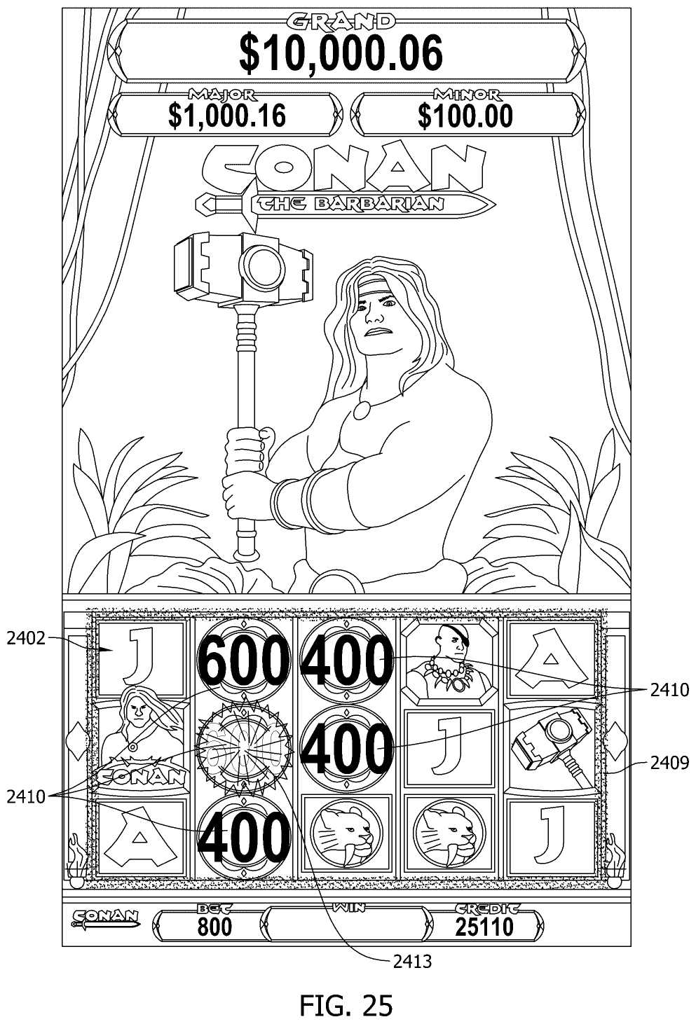

FIG. 25 shows a subsequent time during game play shown in FIG. 24, during which new COR symbols 2410 are added to the matrix 2402. In the embodiment of FIG. 25, after display of the reel boost is initiated, and specifically after display of the metamorphic feature animation, the anticipation effect 2409 is displayed around the matrix 2402. The anticipation effect 2409 of FIG. 25 is substantially the same as the anticipation effect 1809 shown in FIGS. 19-22 and is displayed around the matrix 2402 until all new COR symbols have been added to the matrix 2402. Additionally, as shown in FIG. 25, display of the new COR symbols 2410 occurs individually and in increasing order of credit value of the new COR symbols 2410. For example, all 400 credit COR symbols 2410 are first revealed prior to revealing the 600 credit COR symbols 2410. In the example embodiment, a reveal effect 2413 of an explosion animation around the new COR symbol is provided when revealing a new COR symbol 2410. In other embodiments, any suitable reveal effect may be used.

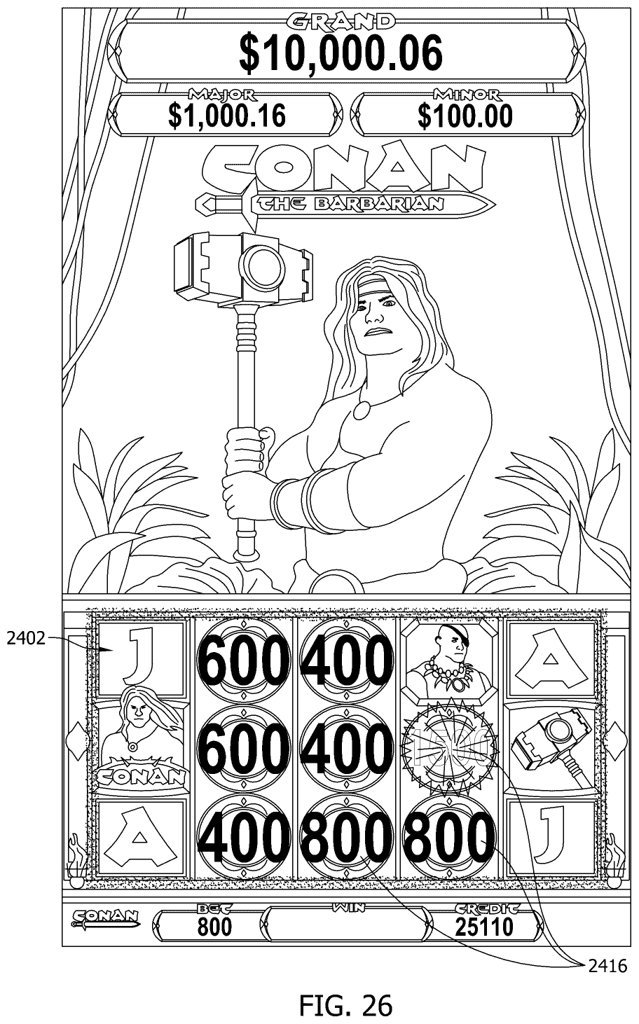

FIG. 26 shows a subsequent time during game play shown in FIG. 25, during which further new COR symbols 2418 are added to the matrix 2402.

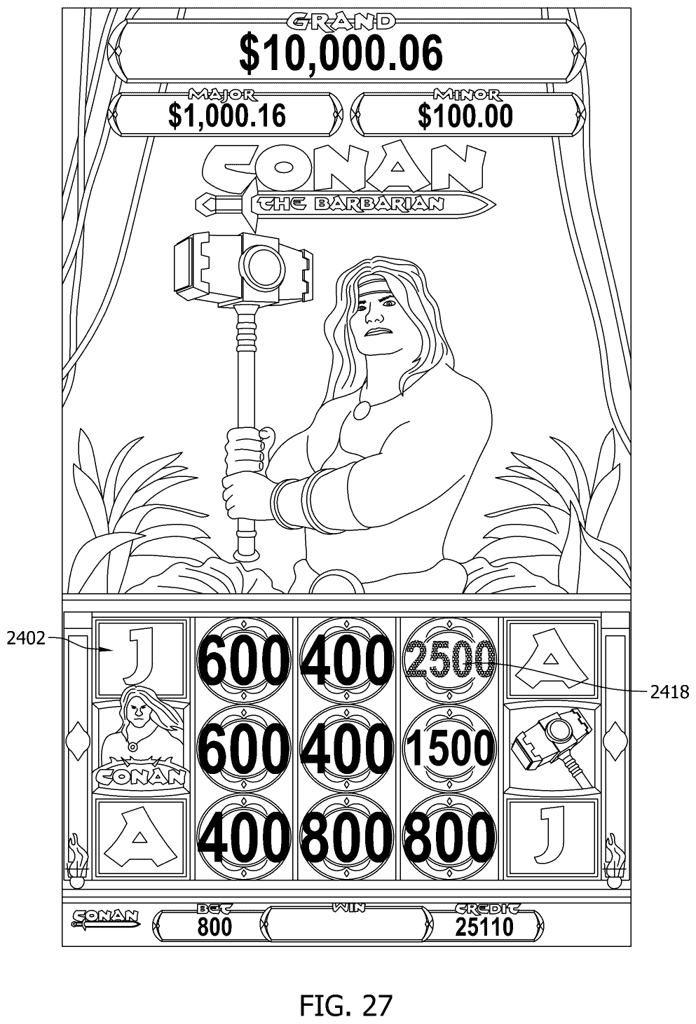

FIG. 27 shows a subsequent time during game play shown in FIG. 26, during which all new COR symbols 2418 are added to the matrix 2402 and the anticipation effect 2409, shown in FIG. 25 is removed. As shown in FIG. 27, the second final outcome of the game is displayed.

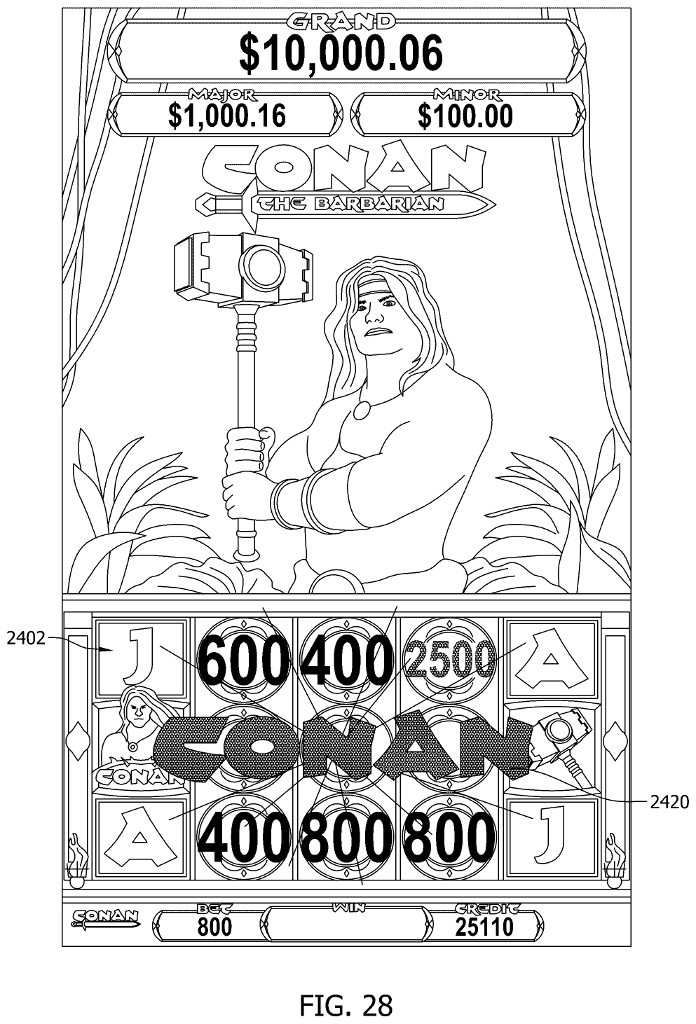

FIG. 28 shows a subsequent time during game play shown in FIG. 26, during which an end game graphic 2420 displayed over the matrix 2402.

While the disclosure has been described with respect to the figures, it will be appreciated that many modifications and changes may be made by those skilled in the art without departing from the spirit of the disclosure. Any variation and derivation from the above description and figures are included in the scope of the present disclosure as defined by the claims.

What is claimed is:

1. An electronic gaming device comprising:
a memory for storing computer executable instructions; and
at least one processor in communication with the memory, wherein the instructions, when executed by the at least one processor, cause the at least one processor to:
generate a first outcome of a game based on a first random number generator (“RNG”) output, the first outcome including a plurality of symbols positioned on a plurality of reels;
determine that the first outcome does not include a winning symbol combination of a first symbol type;
in response to the determination, execute a reel boost mechanic enhancement including determining whether to modify the first outcome by adding at least one symbol of the first symbol type to a first reel;
determine that the modified first outcome increases an award outcome of the game as compared to the first outcome; and
cause display of the modified outcome including the modified first reel with the at least one added symbol.

2. The electronic gaming device of claim 1, wherein executing the reel boost mechanic enhancement further causes the at least one processor to:
identify the first reel based on the first reel not including the first symbol type for the first outcome; and
determine to add the at least one symbol of the first symbol type to the first reel by performing a first lookup using a second RNG output and a first lookup table associated with the first reel.

3. The electronic gaming device of claim 2, wherein executing the reel boost mechanic enhancement further causes the at least one processor to:
identify, based on the determination to modify the first outcome, a second reel of the plurality of reels that does not include the first symbol type for the first outcome; and
determine to not add at least one symbol of the first symbol type to the second reel by performing a second lookup using a third RNG output and a second lookup table, wherein the first lookup table and the second lookup table each contain different weighted probabilities of adding the first symbol type to the corresponding first reel and second reel.

4. The electronic gaming device of claim 3, wherein executing the reel boost mechanic enhancement further causes the at least one processor to:
terminate the reel boost mechanic enhancement in response to the determination to not add at least one symbol of the first symbol type to the second reel.

5. The electronic gaming device of claim 1, wherein the instructions further cause the at least one processor to:
determine a second outcome of the game based on the modified first outcome; and
determine whether the second outcome includes a winning combination of the first symbol type to determine that the modified first outcome increases the award outcome of the game.

6. The electronic gaming device of claim 5, wherein the instructions, when executed by the processor, cause the processor to:
determine that the first outcome includes a winning combination of a second symbol type; and
based on the determination, cause display of the first game outcome; and
cause display of the second outcome after display of the first game outcome.

7. The electronic gaming device of claim 5, wherein the instructions, when executed by the processor, cause the processor to:
determine that the first outcome does not include a winning combination of a second symbol type; and
based on the determination, cause display of the second game outcome by overlaying the at least one symbol of the first symbol type onto the first reel while the first reel is spinning.

8. The electronic gaming device of claim 1, wherein the reel boost mechanic enhancement may be executed during at least one of a base game and a bonus game.

9. The electronic gaming device of claim 1, wherein the reel boost mechanic enhancement is executed in response to performing a lookup of a weighted table using a second RNG output.

10. A method of electronic gaming implemented by at least one processor in communication with at least one memory, the method comprising:
generating a first outcome of a game based on a first random number generator (“RNG”) output, the first outcome including a plurality of symbols positioned on a plurality of reels;
determining that the first outcome does not include a winning symbol combination of a first symbol type;
in response to the determination, executing a reel boost mechanic enhancement including determining whether to modify the first outcome by adding at least one symbol of the first symbol type to a first reel;
determining that the modified first outcome increases an award outcome of the game as compared to the first outcome; and
causing display of the modified outcome including the modified first reel with the at least one added symbol.

11. The method of claim 10, wherein executing the reel boost mechanic enhancement further comprises:
identifying the first reel based on the first reel not including the first symbol type for the first outcome; and
determining to add the at least one symbol of the first symbol type to the first reel by performing a first lookup using a second RNG output and a first lookup table associated with the first reel.

12. The method of claim 11, wherein executing the reel boost mechanic enhancement further comprises:
identifying, based on the determination to add at least one symbol of the first symbol type to the first reel, a second reel of the plurality of reels that does not include the first symbol type for the first outcome; and
determining to not add at least one symbol of the first symbol type to the second reel by performing a second lookup using a third RNG output and a second lookup table, wherein the first lookup table and the second lookup table each contain different weighted probabilities of adding the first symbol type to the corresponding first reel and second reel.

13. The method of claim 12, wherein executing the reel boost mechanic enhancement further comprises:
terminating the reel boost mechanic enhancement in response to the determination to not add at least one symbol of the first symbol type to the second reel.

14. The method of claim 11 further comprising:
Determining a second outcome of the game based on the modified first outcome; and
determining whether the second outcome includes a winning combination of the first symbol type to determine that the modified first outcome increases the award outcome of the game.

15. The method of claim 14 further comprising:
determining that the first outcome includes a winning combination of a second symbol type; and
based on the determination, causing display of the first game outcome; and
causing display of the second outcome after display of the first game outcome.

16. The method of claim 14 further comprising:
determining that the first outcome does not include a winning combination of a second symbol type; and
based on the determination, causing display of the second game outcome by overlaying the at least one symbol of the first symbol type onto the first reel while the first reel is spinning.

17. At least one non-transitory computer-readable storage medium with instructions stored thereon that, in response to execution by a processor, cause the processor to:
generate a first outcome of a game based on a first random number generator (“RNG”) output, the first outcome including a plurality of symbols positioned on a plurality of reels;
determine that the first outcome does not include a winning symbol combination of a first symbol type;
in response to the determination, execute a reel boost mechanic enhancement including determining whether to modify the first outcome by adding at least one symbol of the first symbol type to a first reel;
determine that the modified first outcome increases an award outcome of the game as compared to the first outcome; and
cause display of the modified outcome including the modified first reel with the at least one added symbol.

18. The non-transitory computer-readable storage medium of claim 17, wherein executing the reel boost mechanic enhancement further causes the processor to:
identify the first reel based on the first reel not including the first symbol type for the first outcome; and
determine to add the at least one symbol of the first symbol type to the first reel by performing a first lookup using a second RNG output and a first lookup table associated with the first reel.

19. The non-transitory computer-readable storage medium of claim 18, wherein executing the reel boost mechanic enhancement further causes the processor to:
identify, based on the determination to add at least one symbol of the first symbol type to the first reel, a second reel of the plurality of reels that does not include the first symbol type for the first outcome; and
determine to not add at least one symbol of the first symbol type to the second reel by performing a second lookup using a third RNG output and a second lookup table, wherein the first lookup table and the second lookup table each contain different weighted probabilities of adding the first symbol type to the corresponding first reel and second reel.

20. The non-transitory computer-readable storage medium of claim 19, wherein executing the reel boost mechanic enhancement further causes the processor to:
terminate the reel boost mechanic enhancement in response to the determination to not add at least one symbol of the first symbol type to the second reel.

21. An electronic gaming device comprising:
a memory for storing computer executable instructions; and
a processor in communication with the memory, wherein the instructions, when executed by the processor, cause the processor to:
generate a preliminary outcome of a game based on a first random number generator (“RNG”) output, the preliminary outcome including a plurality of symbols positioned in a plurality of reels;
determine that the preliminary outcome of the first game instance does not include a winning symbol combination of a first symbol type;
in response to the determination, change the preliminary outcome to a modified outcome by altering at least one reel of the plurality of reels by to include the first symbol type;
determine that the modified outcome does not include a winning symbol combination of the first symbol type; and
in response to determining that the modified outcome does not include a winning symbol combination of the first symbol type, cause display of the preliminary outcome of the game.

22. An electronic gaming device comprising:
a memory for storing computer executable instructions; and
a processor in communication with the memory, wherein the instructions, when executed by the processor, cause the processor to:
generate a first outcome of a game based on a first random number generator (“RNG”) output, the first outcome including a plurality of symbols positioned in a plurality of reels;
determine to execute a reel boost mechanic enhancement based on the first outcome and by performing a first lookup using a second RNG output and a first lookup table, wherein executing the reel boost mechanic enhancement causes the processor to:
identify a first reel of the plurality of reels that does not include a first symbol type for the first outcome;
perform a second lookup using a third RNG output and a second lookup table associated with the first reel;
determine to add a first number of a first symbol type to the first reel based on the second lookup;
in response to the determination, identify a second reel of the plurality of reels that does not include the first symbol type for the first outcome;
perform a third lookup using a fourth RNG output and a third lookup table associated with the second reel; and
determine to add a second number of the first symbol type to the second reel based on the third lookup; and
determine a second outcome of the game based on the executed reel boost mechanic enhancement.
